(19) United States
(12) Patent Application Publication
(10) Pub. No.: US 2025/0111803 A1
(43) Pub. Date: Apr. 3, 2025

(54) HAPTIC DEVICE FOR TACTILE BROADCASTING

(71) Applicant: OneCourt Technologies, Inc., Seattle, WA (US)

(72) Inventors: Jerred Mace, Seattle, WA (US); Andrew Buckingham, Kirkland, WA (US); Antyush Bollini, Bothell, WA (US); Nicholas Durand, Seattle, WA (US); Caden Wakefield, Edgewood, WA (US); Jason Bentley, Littleton, CO (US)

(21) Appl. No.: 18/898,145

(22) Filed: Sep. 26, 2024

Related U.S. Application Data
(60) Provisional application No. 63/541,611, filed on Sep. 29, 2023.

(51) Int. Cl. G09B 21/00; G06F 3/01; G06F 3/16

(52) U.S. Cl. CPC G09B 21/007; G06F 3/016; G06F 3/167

(57) ABSTRACT

A device includes a housing, a cover coupled to the housing, and a plurality of actuators. The cover has a surface with regions in which haptics are output, tactile features associated with a sporting event, and braille characters. The plurality of actuators are disposed within the housing and actuate to output haptics within the regions. The device receives data associated with at least one actuator of the plurality of actuators to actuate, and causes, based on the data, the at least one actuator to actuate to output a haptic within the one or more regions. The haptics that are output may be unique from one another as a way to characterize the events taking place during the sporting event. The device may also output audio associated with the sporting event.

### CROSS-REFERENCE TO RELATED APPLICATIONS

This application claims priority to U.S. Provisional Patent Application No. 63/541,611, filed Sep. 29, 2023, entitled “Haptic Device for Spatial Animation,” the entirety of which is herein incorporated by reference.

### BACKGROUND

Sporting events often bring people together and allow them to share in the joys of competition. For some individuals, such as those with visual disabilities (e.g., blind or visually impaired), audio is often the primary way to engage in sports. As a result, people with visual disabilities may rely on audio commentary, whether via television or radio, to provide details about the sporting event. While friends or family members may provide play-by-play commentary, this often creates a sense of dependency and/or burden. In addition, pure audio commentary may fail to communicate spatial details associated with the sporting event, such as a certain play, maneuver, and so forth. These spatial details are often crucial to the comprehension, development, and progression of the sporting event. As a result, people with visual disabilities, among others, are left unaccommodated.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example device configured to output haptics, and remote computing resource(s) in communication with the device for causing the haptics to be output, according to examples of the present disclosure.

FIG. 2 illustrates select functional components of the device of FIG. 1, according to examples of the present disclosure.

FIG. 3A illustrates a top view of the device of FIG. 1, according to examples of the present disclosure.

FIG. 3B illustrates an isometric view of the device of FIG. 1, according to examples of the present disclosure.

FIG. 3C illustrates a partial isometric view of the device of FIG. 1, showing example tactile features, according to examples of the present disclosure.

FIG. 4A illustrates an exploded view of the device of FIG. 1, showing components disposed within the device, according to examples of the present disclosure.

FIG. 4B illustrates an exploded view of an alternative device, showing components disposed within the device, according to examples of the present disclosure.

FIG. 5 illustrates example actuators disposed on a printed circuit board (PCB) of the device of FIG. 1 that are actuatable to output haptics, according to examples of the present disclosure.

FIG. 6 illustrates an example sequence of haptics being output on the device of FIG. 1, according to examples of the present disclosure.

FIG. 7 illustrates an alternative cover of the device of FIG. 1, according to examples of the present disclosure.

FIG. 8 illustrates an alternative cover of the device of FIG. 1, according to examples of the present disclosure.

FIG. 9 illustrates an alternative cover of the device of FIG. 1, according to examples of the present disclosure.

FIG. 10 illustrates an alternative cover of the device of FIG. 1, according to examples of the present disclosure.

FIG. 11 illustrates an example use of the device of FIG. 1 with different covers, according to examples of the present disclosure.

FIG. 12 illustrates an example process associated with determining haptics to be output on the device of FIG. 1, according to examples of the present disclosure.

FIG. 13 illustrates an example process associated with determining haptics and audio to be output on the device of FIG. 1, according to examples of the present disclosure.

FIG. 14 illustrates an example process associated with outputting haptics on the device of FIG. 1, according to examples of the present disclosure.

FIG. 15 illustrates an example process associated with determining a cover installed on the device of FIG. 1 for outputting haptics, according to examples of the present disclosure.

### DETAILED DESCRIPTION

This application is directed, at least in part, to systems, methods, and devices that provide haptic outputs to create an immersive experience for people with visual disabilities, according to examples of the present disclosure. The device may include a cover on which the hand(s) of a user rest and a plurality of actuators may be disposed beneath the cover to output haptics associated with a sporting event. For example, as the actuators are actuated, haptics may be felt by the user through the cover. Depending upon events that occur during the sporting event, such as plays, maneuvers, etc., and where those events occur within a field of play, certain actuators may be individually or collectively actuated to provide haptic outputs. In this manner, people with visual disabilities may experience the sporting event by feeling and tracking vibrations moving across the cover. In some instances, audio may additionally be used to supplement the haptic outputs to provide further context, entertainment, and so forth. The device may, therefore, create an independent and accessible solution for people with visual disabilities seeking to experience sporting events.

In some instances, the device may include one or more housings that couple together and within which components of the device are disposed. For example, the device may include a bottom housing and a top housing. In some instances, the cover may couple to the top housing. The bottom housing and the top housing may form a cavity in which the components (e.g., PCBs, battery, actuators, network interfaces, such as network modems, devices, controllers, etc.) are disposed. Alternatively, in some instances, the device may include a single housing that is enclosed via the cover.

The cover provides an interface (e.g., surface) where the user places their hand(s). In some instances, the cover may also include tactile features, such as court lines, fields of play, strike zones, yard lines, or other indicators. In some instances, the tactile features may be embossed or debossed on the cover, thereby providing feedback to the user regarding the placement of their hand(s) within or on a field of play, for example. The tactile features may also assist the user in positioning, locating, etc., their hands on the device and orienting themselves on the device. The cover may include any number indicators (e.g., 10-yard line in football) and/or braille translations, characters, etc., associated with the tactile features and/or indicators.

The actuators may be disposed within the cavity of the device. In some instances, the device may include one or more mounts disposed within the cavity, whereby the actuators may be disposed on, mounted to, or seated on the mount. To provide haptic outputs through the cover, the mount may be disposed vertically beneath the cover. In some instances, the mounts may include receptacles (e.g., pockets, indents, slots, etc.) in which the actuators are situated. The mount may serve to align, orient, etc., the actuators beneath the cover such that the actuators may actuate to impart haptics to certain (and known) areas on the cover. In some instances, the haptics may be output at designated areas (e.g., regions) on the cover. Although described as being mounted to the mounts, the actuators may, in some instances, be mounted directly to PCBs, PCBAs, multi-layered PCBs, etc., within the housings.

In some instances, the plurality of actuators may actuate (e.g., fire) in a direction towards the cover to engage the cover (e.g., a bottom surface of the cover). In some instances, foam, rubber, silicone, etc., may be disposed between an interface of the actuators and the cover. In some instances, each of the actuators may be adhered onto a piece of foam, padding, fabrics, etc. (e.g., Neoprene, rubber silicone, etc.) to dampen vibrations from the actuator and prevent the vibrations moving throughout the entire device, different areas of the cover, a PCB to which the actuators are mounted, etc. In this manner, haptics being output may be localized adjacent to the actuators that are actuated. This has the effect of limiting the haptics to certain areas on the cover to convey spatial information to the user.

In some instances, the actuators may be engaged with a bottom of the cover and, when actuated, may output the haptics through the cover. Alternatively, the actuators may initially be disengaged with the bottom of the cover, and when actuated, may become engaged with the cover to output the haptics. In some instances, the plurality of actuators may include linear resonant actuators (LRA). However, other types of actuators may be used, such as eccentric rotating mass (ERM) actuators, coin vibration ERM actuators, ultrasonic actuators, linear actuators, pneumatic actuators, etc. Any combination of the actuators may be used.

The device may include any number of the actuators and/or the actuators may be individually or collectively actuated to provide haptic outputs. In some instances, the actuators may be arranged in a grid-like fashion. In some instances, the actuators may be arranged as a rectangular, square, circle, or any other shape within the device. In such instances, the mount may accommodate the different shapes, patterns, etc., in which the actuators are arranged. The number of actuators used within the device may permit different levels of granularity of the haptics being output. For example, including more actuators (e.g., a greater number of actuators) may permit a greater fidelity to represent a sporting event being portrayed on the device.

In some instances, the device includes 192 actuators arranged in an 8×24 grid, 288 actuators arranged in a 12×24 grid, 640 actuators arranged in a 40×16 grid, or 512 actuators arranged in a 32×16 grid. However, although a particular number of actuators are described, a different amount of the actuators may be included. Additionally, the actuators may be arranged in different grids or arrays than described. In some instances, a density of the actuators may be the same across the device, and/or different areas of the device may have a greater density of the actuators. Moreover, the actuators may be similarly or differently sized compared to one another.

In some instances, although the device includes a predetermined number of the actuators, depending upon the sporting event being portrayed (e.g., experienced, output, etc.) on the device or a configuration of the device, not all of the actuators may be actuatable. For example, the number of actuators disposed in the device may accommodate different sporting events. However, depending upon the sporting event being portrayed at a particular instance in time, not all of the actuators may be actuatable to output the haptics. For example, football, because of the large field of play, may use more of the actuators than a smaller field of play, such as basketball. However, in some instances, the fields of play for basketball, for example, may be scaled across the cover and the device may have a higher fidelity for basketball than football.

In some instances, regions of the cover may be scaled to increase resolution. For example, when representing a baseball field, a portion of the baseball field corresponding to the infield may be disproportionately sized as compared to the outfield to increase a resolution of haptics within the infield. The size of the infield may be larger than the outfield (even though in actuality the outfield is larger than the infield) to increase haptic resolution within the infield.

In some instances, the actuators may be associated with respective positions on or beneath the cover, or more specifically, certain locations within or outside a field of play (e.g., out of bounds, sidelines, endzones, etc.). The locations of the actuators beneath the cover may be known and such locations may be used when determining which of the actuator(s) to actuate when outputting the haptics. In some instances, the actuators may be mapped to certain locations on the cover, and using the location of the actuators, certain actuators may be actuated to represent events occurring during the sporting event. As will be explained herein, the actuators may be configured to actuate according to different settings, such as intensities, fidelities, periods of time, frequencies, etc. For example, based at least in part on certain events, types of events, etc., associated with the sporting event, the actuators may actuate according to different settings.

Throughout a sporting event different events may occur, where the events describe the sporting event taking place (e.g., hit, pass, catch, etc.). These events may vary and be dependent upon the sporting event. In some instances, the actuators may actuate based on the events associated with sporting event taking place. As will be explained herein, in some instances, the device may communicatively couple to remote computing resources to receive the data associated with the events, which actuator(s) to actuate, etc. In some instances, the remote computing resource(s) may communicatively couple to data service(s) (e.g., data providers, third-party resource(s), etc.) to receive data associated with the sporting events. The remote computing resource(s) may subscribe to the data service(s) to receive data associated with the sporting event. Additionally, the remote computing resource(s) may receive the data on a continual basis, based on predetermined schedules, etc. In some instances, the remote computing resource(s) may subscribe to different data service(s) depending upon the sporting event. However, although described as subscribing to data service(s) to receive the data associated with the sporting event, in some instances, the remote computing resource(s) may generate the data and/or receive the data from other sources. In some instances, the data service(s) may be official data providers of the sporting events.

In some instances, the data received from the data service(s) describes the event taking place. For example, the data may describe the position of the ball, puck, etc., and what is happening to the ball, puck, etc., such as spatial or positional. In this sense, the data received from the data service(s) may indicate what is happening during the sporting event to permit the remote computing resource(s) to determine which of the actuator(s) to actuate. The data may also indicate players involved in the events, a time at which the events occurs, specifics of the event, scores, timing, and so forth. In some instances, the data generated by the data service(s) may be based at least in part on sensor data, image data, etc., generated or received, whether from resource(s) of the data service(s) and/or other entities. For example, sensor(s) may be deployed at the sporting event (e.g., ball tracking technology) to generate the data. Regardless, the data as received from the data service(s) may describe what is happening during the sporting event to permit actuation of the actuator(s).

The data received from the data service(s) may indicate, or be used to determine, the events taking place. The events are output as haptics on the device to provide an immersive experience to the user. As non-limiting examples, for football, events that may be output as haptics may include a pass, catch, run, sack, interception, touchdown, etc. For baseball, events that may be output as haptics may be a strikeout, catch, ball, strike, hit, homerun, walk, etc. For basketball, events that may be output as haptics may be a field goal make, field goal miss, free throw, dunk, turnover, pass, etc. For tennis, events that may be output as haptics may be serves, volleys, aces, etc. However, these events and/or sporting events are exemplary, and the systems, methods, and devices as described herein may output haptics for events of other sporting events, such as car racing, horse racing, golf, soccer, gymnastics, hockey, billiards, chess, cycling, cricket, polo, swimming, skating, volleyball, etc.

In some instances, the device may generate haptics from data or events that are manually entered. For example, in some instances, the sporting event data may not be available. Individuals may quickly create animations on the surface of the device. For example, a parent might draw on a tablet to activate haptics that are output on the device for their child.

The data received from the data service(s) may indicate a location of the event on the football field, baseball field, basketball court, etc., or within a field of play, to allow the device to output haptics associated with the location of the event. For example, using the location of the event taking place, associated actuators on the device may output haptics. In some instances, the remote computing resource(s) may filter the data from the data service(s) based on the haptics to be output at the device. As an example, the data received from the data service(s) may indicate locations of the players within the field of play, however, such data may be filtered and not output on the device (e.g., too much haptic outputs may be confusing, distracting, etc.). In some instances, the remote computing resource(s) may filter the data to determine a location of the ball, puck, etc., and/or a type of the event (e.g., pass, run, catch, hit etc.). The remote computing resource(s) may also determine a score, inning, etc., of the sporting event.

In some instances, the remote computing resource(s) may make inferences from the data. For example, if the data indicates a throw in baseball from third base to first base, the remote computing resource(s) may determine a trajectory of the baseball from third base to first base (e.g., knowing the starting and ending location of the throw, other detail such as velocity and launch angle, etc.). As will be explained herein, the device may output haptics associated with the trajectory of the baseball from third base to first base.

In some instances, the remote computing resource(s) may extract details from the data received from the data service(s). For example, the remote computing resource(s) may extract a location of the ball, the ball carrier, and/or the action. In some instances, extracting the location may involve determining coordinate positions (e.g., X and Y) associated with the ball, the ball carrier, and/or the action within the field of play.

In some instances, the remote computing resource(s) may characterize (e.g., classify, label, etc.) the events referenced within the data. For example, the remote computing resource(s) may characterize an event as a pass, run, tackle, touchdown, etc., and each event may be assigned a unique identifier. In some instances, the unique identifiers may be associated with a haptic language that is used to output the haptics. For example, the remote computing resource(s) may translate the data from the data service(s) into a unique identifier of the haptic language that is used to control the actuator(s). A “unique identifier” may be a haptic effect that corresponds to each event uniquely, such that the user may differentiate between events that are occurring. In other words, the haptic language may communicate specific and discernible events.

Different events may be associated with different haptics, and the unique identifier associated with the haptic language may indicate the haptics for the different events. As an example, the data may indicate a type of tackle for football (e.g., wrap up, sack, hit intensity, change in acceleration, etc.), a type of catch in football (e.g., dive, jump, etc.), a type of hit in baseball (e.g., pop-up, line drive, fly out, etc.), etc. The remote computing resource(s) may use this information for translating the event into the haptic language. Each unique identifier of the haptic language may be used to control the setting(s) and/or determine how to represent the event as haptic outputs on the device. For example, if the event is a sack in football, the event may be translated into the haptic language, whereby the haptic language indicates the haptics to be output for sacks. These unique identifiers may increase fidelity when outputting haptics for different events, where different events may be associated with different haptics, to provide an immersive, descriptive, and more comprehensive experience to the user. The data provided to the remote computing resource(s) may indicate details of the events to permit the remote computing resource(s) to determine the unique identifiers for the events taking place.

The remote computing resource(s) may determine which of the actuator(s) to actuate based at least in part on the data and the event taking place. The remote computing resource(s) may map a location of the event (e.g., within an actual field of play) to certain actuators on the device. Associated with a virtual field of play For example, based at least in part on the location of the pass, the remote computing resource(s) may determine which of the actuators to actuate in order to recreate the pass on the device. The remote computing resource(s) may know the locations of the actuators on the device, and their relative location within a football field, for example, to determine which of the actuator(s) to actuate for a particular event taking place. As an example, if the event was a touchdown, the remote computing resource(s) may know those actuator(s) disposed in, or associated with, the endzone for causing those actuator(s) to actuate.

In some instances, the location of the event may not map directly to a location of an actuator, or the event may occur at a location that encompasses (e.g., spans) more than one actuator. Multiple actuators may be used to indicate these events and/or the actuators may output haptics at varying degrees (e.g., 50% intensity). To provide for different effects of the haptic output, the degree of activation may be based at least in part on the distance of each actuator to the location of the event on the cover. Varying the intensity may be used to taper off the haptic outputs to smooth transitions. Moreover, by varying the intensity, when an event moves across the cover by a distance that is less than the width of the actuator, a change in vibration may still be felt.

Furthermore, the remote computing resource(s) may determine setting(s) of the actuators, such as intensities, fidelities, periods of time, frequencies, etc. The setting(s) may be determined based at least in part on characteristic(s) of the event, a type of the event, the unique identifier, etc. For example, whether a pass was caught, dropped, etc., may be associated with different haptics. Moreover, whether a pass was a touchdown, for example, may be associated with different haptics. Here, different events may be associated with, or characterized by, different haptics output by the device. As another example, the snap of a football may include a vibration at a first intensity, while a catch of the football may include a vibration at a second intensity greater than the first intensity. As yet another example, if a player is running with the football, above a certain threshold speed, the actuators may output different haptics than if the player is running with the football below the certain threshold speed. This type of haptic output may increase fidelity to provide the user with realistic and contextual information about the events taking place.

In some instances, the device may receive instructions, commands, etc., from the remote computing resource(s) as to which of the actuator(s) are to be actuated as well as setting(s) of the actuator(s) for adjusting the haptics to be output (e.g., intensities, fidelities, periods of time, frequencies, etc.). Responsive to receiving data from the remote computing resource(s), the device may cause the actuator(s) to actuate according to the setting(s). Other data, however, may be received by and output by the device, such as a score, timing (e.g. inning, period, etc.), analytics of the sporting event, the player, an indication of a player associated with the event, etc. The device may continuously receive data from the remote computing resource(s) to allow the user to follow along, play-by-play, etc., during the sporting event. By sequencing and varying the intensity, duration, and density of the haptics output by the actuator(s) over time, the device is able to animate haptics and intuitively communicate spatial details through touch about the sporting event.

To illustrate example haptics, envision the device is configured to provide haptic outputs for football. The cover may include tactile features (e.g., textures, material breaks, etc.) associated with the yard lines, endzones, sidelines, etc., on the football field. In addition, the tactile features may include indications (in braille) of the associated yard lines. The tactile lines and/or the indications may communicate specific regions on the device, or the field of play, to the user. For example, the tactile lines may be embossed into or on the cover. During use, the user may place, position, etc., their hands, palms, fingers, and fingertips on the cover based on the tactile lines. Beneath the cover, certain actuators may be associated with, or mapped to, respective locations on the football field. For example, certain actuators may be disposed beneath the endzone, certain actuators may be disposed along the 50 yard line, and so forth. Each actuator may be associated with a respective position, location, or area on the football field. As indicated above, the respective locations of the actuators may be stored for causing certain actuators to be actuated in response to the events taking place.

As an example event, consider that during a football game a pass is completed as a score in the endzone. Upon a snap of the football, actuators corresponding to the location of the football at the snap may vibrate at a first frequency. As the quarterback, for example, moves in the pocket or scrambles before attempting the pass, corresponding actuators may vibrate at the first intensity, or at a second intensity greater than the first intensity, to indicate a movement of the football. When the football is thrown, corresponding actuators associated with the location at which the football is thrown may vibrate. In some instances, actuators located along a trajectory of the football, between the location at which the football is thrown to the location at which the football is caught, may vibrate. For example, if the football is thrown from the 30 yard line to the endzone, actuators located along a trajectory of the football, from the 30 yard line to the endzone, may vibrate. This may create a “trail” or path of the ball. The timing of when to actuate the actuators, as the football moves from the 30 yard line to the endzone, may be synchronized with the location of the football. This allows the user to track the location of the football during the throw. This is just one example, and the device may, in some instances, output haptics associated with movements of the main characters of the play (e.g., quarterback, receiver, ball, etc.).

In some instances, as the football is traveling along the trajectory, the actuators may vibrate at the first intensity or the second intensity. When the football is caught in the endzone for a touchdown, the actuators associated with the endzone may vibrate at a third intensity that is greater than the first intensity and/or the second intensity. In some instances, an entirety of the actuators beneath the endzone may vibrate, or a specific location within the endzone at which the catch was made may vibrate (e.g., to indicate a specific area of the endzone in which the pass was caught).

As noted above, the device may output audio associated with the sporting event. While touch may convey spatial details about the sporting event, audio commentary may convey emotion, explain strategy, and/or highlight key contextual information about the sporting event. In some instances, the device may receive the audio from the remote computing resource(s), other devices (e.g., radio, TV broadcasts, etc.), etc. The audio may be output in association with, and coordinated with, output of the haptics. For example, the device may include a speaker or audio jack for headphones that outputs audio associated with the sporting events. In some instances, the audio may indicate the events taking place, the players involved, commentary from broadcasters, and so forth.

In some instances, the audio may be synchronized with the haptics output by the actuators. In some instances, the audio may be delayed (e.g., via a buffer) to synchronize the audio with the haptic being output. For example, as the sporting event is taking place in real-time, the data may be generated at a delay. In turn, the data received from the remote computing resource(s) may be received at a delay as compared to the audio (which may include a lesser delay). In some instances, using time stamps, for example, the audio and the haptics may be output synchronously. As such, when a pass occurs in a football field, the user hears the word “pass” the user simultaneously feels the ball move via the haptics output from the actuators.

In some instances, the remote computing resource(s) may generate the audio that is output on the device based on the events, their characterization, etc. For example, when the remote computing resource(s) determine that an event associated with a pass has occurred, the remote computing resource(s) may generate audio data indicating the pass, a location of the pass, a flight of the pass, who the pass is intended for, etc. These characteristic(s) may be determined from the data received from the data service(s), whereby the remote computing resource(s) may annotate the data to generate the audio output on the device. Alternatively, in some instances, the device itself may generate the audio using the sporting event data, data received from the remote computing resource(s), and so forth.

In some instances, the remote computing resource(s) may leverage artificial intelligence (AI), large language models (LLMs), or machine-learning (ML) model(s) to generate the audio. For example, AI may be used to create data-generated broadcast commentary that may be synchronized with the device, and customized to the desire of the user. By leveraging AI language models, AI voice generators, and datasets, users may personalize their experience. For example, some users might choose to have commentary that focuses on gameplay strategy, while others may prefer commentary that explains the sporting event (e.g., rules, scoring, etc.).

In some instances, the device may output haptics associated with live sporting events. For example, remote computing resource(s) may receive the data in real-time or substantially real-time (e.g., after processing, etc.). In such instances, the remote computing resource(s) may determine the haptics to be output and communicate data associated with the haptics to the device for output. This may, for example, reduce perceived delays on behalf of the user and allow the user to experience the sporting event live. Alternatively, in some instances, the device may receive data associated with a recorded or previous sporting event.

In some instances, the device may include interchangeable covers that are removably coupled to the first housing and/or the second housing. The interchangeable covers may permit the device to be used across a plurality of sporting events, such as football, hockey, baseball, soccer, tennis, basketball, and so forth. In some instances, the cover may be interchangeable depending upon the sporting event, or the type of sporting event the device is configured to accommodate. In some instances, the cover may be interchangeable via snap-fits, pressure-fits, fasteners, quick-release mechanisms, and so forth. Depending upon the cover installed on the device, certain actuators may be enabled and disabled, or capable of being activated. For example, football may utilize more actuators than baseball given the size and shape of the field of play. A football field is rectangular in shape, whereas a baseball field is conoid. The device may be configured to recognize the cover, and in response, permit certain actuators to be actuated. Certain actuators that were within the field of play for football may be outside the field of play for baseball. These actuators, when a cover associated with baseball is coupled to the device, may be deactivated given their location outside the field of play. Additionally, depending on the cover installed on the device, settings, functions the buttons, and alterations to certain haptic effects may be adjusted.

In some instances, the device may determine the cover installed on the device, and transmit an indication of such to the remote computing resource(s) for use to determine which of the actuators to actuate, or which of the actuators are capable of being actuated. In some instances, RFID, pin connections, etc., may be used to determine the cover coupled to the device. The respective covers may have tactile features that indicate, for example, fields of play, yard lines, court lines, free-throw lines, etc. The tactile features and/or the indications may be based on the sporting event. The tactile features may situate the user on the haptics output from the actuators.

In some instances, a universal cover may couple to the housing, whereby the universal cover may be configured for multiple sporting events. For example, the universal cover may have tactile features that may be adjustable (e.g., retracted and extended into and/or out of the cover) depending upon the sporting event. In some instances, the universal cover may include universal tactile lines (e.g., a rectangular field of play) to accommodate soccer, swimming, football, basketball, etc. The user may be permitted to toggle between different sporting events to track multiple sporting events happening simultaneously and personalize their experience.

In some instances, removable, replaceable, etc., pieces (e.g., objects, articles, specimens, etc.) may be disposable at various locations on the cover. For golf, by way of example, every hole and course are different. Different vibrations may be used to instruct the building of each hole using tactile game pieces. A location associated with the hole may vibrate and the user may place a first piece (e.g., a piece representative of the hole) at the vibration. A location associated with a sand trap may vibrate and the user may place a second piece (e.g., a piece representative of the sand trap) at the vibration. In this manner, the user may plot the pieces representative of the golf hole at certain locations, and then after placing the pieces, haptics may be output for allowing the user to follow along players playing the hole.

The remote computing resource(s) may communicate with any number of devices for outputting haptics. For example, within an arena, stadium, sporting event venue, etc., there may be any number of devices used across users. For each of the devices and across the sporting events, the devices may output haptics for different users. Moreover, although the discussion is described herein with regard to the remote computing resource(s) determining the haptics, the actuators to actuate, the setting(s), etc., the devices themselves may in some instances determine which actuators to actuate, the setting(s) by which the actuator(s) actuate, and so forth. Any level of split processing may be employed between the device, the remote computing resource(s), the data service(s), and/or other systems, devices, etc.

In some instances, the user may have the ability to configure the device according to preference(s). The preference(s) may be stored or associated with a profile of the user, where the preference(s) may be used by the remote computing resource(s) and/or the device when outputting the haptics, audio, etc. In some instances, the user may indicate the types of events to be output on the device, the setting(s) of the actuator(s), events associated with certain players, etc. As an example, the user may define setting(s) for an intensity of haptics for a catch, as compared to a run, in football. As another example, the user may prefer to only have haptics for passes that are caught, as compared to passes that are incomplete or dropped. As yet another example, the user may prefer to know locations, actions, etc., of certain players throughout the sporting event. In some instances, beginner, intermediate, and advanced profiles may be used to quickly select different levels of detail. For example, a beginner may only get ball location and limited audio while the advanced may get numerous haptic and audio toggles.

The device may include suitable computing and hardware components to permit outputs of the haptics, audio, etc. For example, the device may include batteries, network interface(s) (e.g., Wireless, Cellular, Bluetooth, etc.), heat-dissipating elements, shielding foams, input/output components (e.g., buttons, switches, speaker(s), etc.), sensor(s) (e.g., microphone(s), accelerometers, etc.). Buttons, for example, may be disposed on the housings and/or the cover of the device. In some instances, the buttons may be used to control one or more operations associated with the device, such as powering on and off the device, selecting a sporting event, outputting audio, etc.

In some instances, rather than the actuators being fixed at certain locations within the device, the device may include moveable actuators that are capable of moving in one or more directions beneath the cover. As an example, a gantry-style system may be disposed beneath the cover and the gantry-style system may move (e.g., translate) in one or more directions to move the actuators to corresponding locations associated with the event. In some instances, the gantry-style system may move a small array of actuators to increase resolution. The gantry-style system may be non-mechanical or electromagnetic based. As another example, rather than a actuator being coupled to the gantry-style system, one or more magnets may couple to the gantry-style system and as the gantry-style system moves the magnets, the magnets may interface with pins (e.g., rods, posts, etc.) that lift from within or beneath the cover to contact the hands of the user. When the magnets move away from the pins, those pins may retract and when the magnets move towards other pins, those pins may extend. The cover, in these instances, may include channels in which the pins are disposed and the pins are translatable within the channels to engage the user.

In some instances, the cover may include different regions, interfaces, sections, etc., that output different information associated with the sporting event. For example, if the cover is associated with baseball, a first section may include tactile features associated with a baseball diamond and a second section may include tactile features associated with the strike zone. In this manner the cover may be segmented into different areas to output different information to the other. Other examples may include a section that indicates strikes, balls, and outs, a section that indicates the score, a section that indicates the inning, and so forth.

The device may, in some instances, include sensor(s) disposed beneath or integrated with the cover. The sensor(s) may track a location of the user on the cover, as a location of a placement of their hands, fingers, etc. In some instances, the location of the user may be used to provide outputs to correct the user as to the placement of their hands. Moreover, the sensor(s) may be used to determine an amount of force the user presses against the cover to feel the haptics. Sensor data generated by the sensor(s) may be used to control haptics, such as increasing or decreasing an intensity of the actuator(s), an amount of time the actuator(s) vibrate, etc. Example sensor(s) may include proximity sensor(s), capacitive sensor(s), resistive sensor(s), etc.

In some instances, the device, such as the housings, are manufactured from plastics, composites, metals, etc. The cover, in some instances, may be manufactured from silicone, elastomeric materials, etc., to provide a soft and comfortable interface for the user as well as functionality for vibration isolation. Noted above, the silicone cover may be embossed or debossed with tactile features to orient the user on cover. Moreover, in some instances, the cover (or portions of the device) may be curved to improve wrist posture or to increase a surface area of the hands (e.g., palms, fingers, etc.) in contact with the cover (e.g., given the curvature of the hand). For example, on a flat (e.g., planar) cover, the user may have to press their hands into contact with the cover, whereas a curved cover may be more ergonomic and form-fitting to the natural position of the hand.

Although described in use with sporting events, the systems, methods, and devices described herein may be applicable to other environments, types of entertainment, applications, etc. For example, a device may output haptics for spatial animation associated with a movie, play, etc., such as the location of characters, actions taking place, maps, diagrams, video games, artworks, concert stages, classrooms, workplaces, etc. In such instances, the device, such as the cover, may be configured to accommodate the particular application.

Accordingly, the systems, methods, and devices may output haptics that dynamically respond to data to create immersive and meaningful experiences for people with visual disabilities. The device utilizes the actuators to output haptics as a way to communicate live gameplay, enabling users to “watch” sports with their hands. With the systems, methods, and devices, users experience the sporting event by feeling and tracking vibrations moving across the device to gain insight into events taking place. Moreover, increasing the fidelity of haptics with real-time data enables a greater comprehension and immersion for people with visual disabilities.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

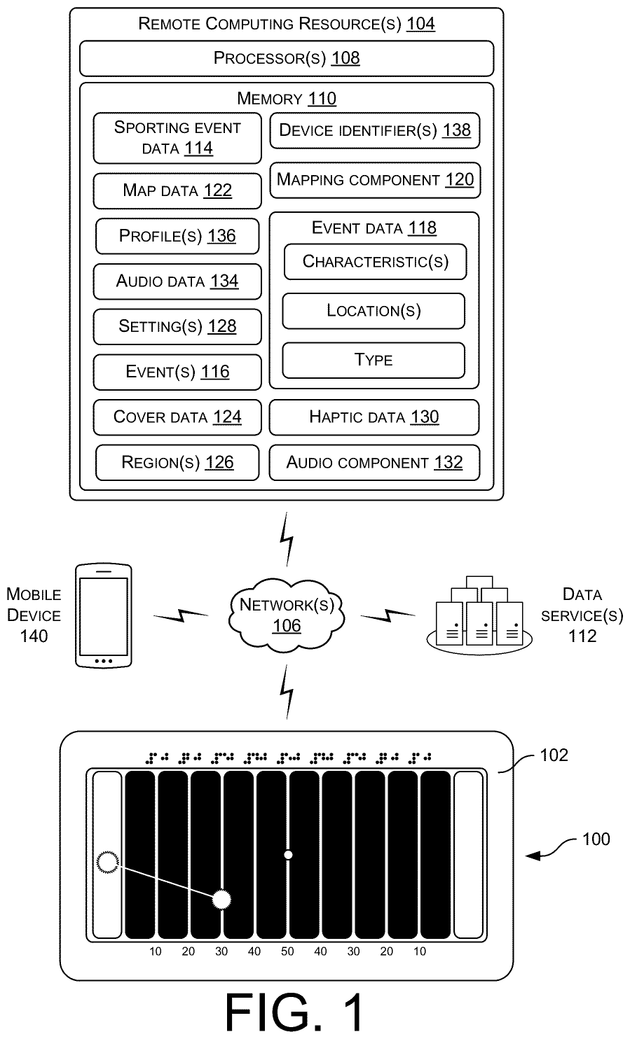

FIG. 1 illustrates an example device 100 configured to output haptics associated with a sporting event, according to examples of the present disclosure. Details of the device 100 are described herein, however, as shown in FIG. 1, the device 100 may include a cover 102 associated with a football field. In this example, the device 100 may be configured to output haptics associated with football. In some instances, the device 100 may be used at a field, arena, stadium, etc., at which a game of football is being played, the device 100 may be used in-home, and/or other environments. However, although discussed in FIG. 1 in relation to football, the device 100 may output haptics associated with other sporting events. In such instances, the cover 102 may be different than illustrated in FIG. 1.

The device 100 may communicatively couple to remote computing resource(s) 104 via one or more network(s) 106. The remote computing resource(s) 104 is shown including processor(s) 108 and memory 110, where the processor(s) 108 may perform various functions and operations associated with outputting haptics at the device 100, and the memory 110 may store instructions executable by the processor(s) 108 to perform the operations described herein. In some instances, the remote computing resource(s) 104 may communicatively couple to one or more data service(s) 112 via the one or more network(s) 106 to receive sporting event data 114 associated with sporting events. The sporting event data 114 may represent real-time streaming data of all details of the sporting event, or key details, information, etc., associated with events 116 taking place during or within the sporting event.

The remote computing resource(s) 104 may subscribe to the data service(s) 112 to receive the sporting event data 114. In some instances, the remote computing resource(s) 104 may receive the sporting event data 114 on a continual basis, based on predetermined schedules, etc. The remote computing resource(s) may subscribe to different data service(s) 112 depending upon the sporting event (e.g., football, baseball, hockey, etc.). However, although described as subscribing to the data service(s) 112 to receive the sporting event data 114, in some instances, the remote computing resource(s) 104 may generate the sporting event data 114 and/or receive the sporting event data 114 from other sources.

The sporting event data 114 may indicate events 116 taking place during the sporting event. The events 116 may be associated with maneuvers, actions, plays, acts, etc., that occur during the sporting event. Throughout a sporting event different events 116 may occur, where the events 116 describe the sporting event taking place (e.g., hit, pass, catch, etc.). These events 116, or the type of events 116, may vary and be dependent upon the sporting event. The events 116 may be routine gameplay, such as passes, hits, etc., scoring, such as touchdowns, points, etc., and so forth. The sporting event data 114 may also indicate specifics of the events 116, such as the players involved, a movement of the players during the event 116, a location of the events 116 on a field of play, from one location to another, a time at which the event 116 occurred, movements of the players, movement of a ball, etc. As will be explained herein, the events 116 may be associated with haptics that are output on the device 100 to provide an immersive experience to users utilizing the device 100.

The sporting event data 114 received from the data service(s) 112 may indicate, or be used to determine, the events 116 taking place. The events 116, as will be explained herein, are output as haptics on the device 100. As non-limiting examples, for football, events that may be output as haptics may include a pass, catch, run, sack, interception, touchdown, field goal, tackle, offsides, pass breakup, etc. The sporting event data 114 received from the data service(s) 112 may indicate these and other events taking place.

Moreover, although described in use with football, events for other sporting events may be determined from the data service(s) 112. For example, events for other sporting events, such as car racing, horse racing, golf, soccer, gymnastics, hockey, billiards, chess, cycling, cricket, polo, swimming, skating, volleyball, etc. may be determined. For baseball, events that may be output as haptics may be a strikeout, catch, ball, strike, hit, homerun, walk, etc. For basketball, events that may be output as haptics may be a field goal make, field goal miss, free throw, dunk, turnover, pass, etc. For tennis, events that may be output as haptics may be serves, volleys, aces, etc.

Still, in some instances, the device 100 may be used to engage in games with other users, such as chess, checkers, card games, etc. In such instances, the cover 102 may be configured accordingly, for example, to include a board game. In addition, moves, plays, events, etc., of the players may be tracked and output on the cover 102.

In some instances, the remote computing resource(s) 104 may utilize the sporting event data 114 to determine event data 118 that is associated with the events 116 during the sporting event. In some instances, the event data 118 may indicate a type of the event 116 (e.g., hit, tackle, catch, pass, etc.), location(s) associated with the event 116 in the field of play (e.g., yard line), and/or other characteristic(s). The characteristic(s), for example, may indicate the players involved in the event 116, sub-types of the actions (e.g., diving catch, jumping catch, sliding catch, etc.), and so forth.

In some instances, the remote computing resource(s) 104 may make inferences from the sporting event data 114 to determine the event data 118. For example, if the sporting event data 114 indicates a throw in football from a first yard line and/or hashmark to a second yard line and/or hashmark, the remote computing resource(s) 104 may determine a trajectory of the football between such locations. While the trajectory of the throw may not be indicated within the sporting event data 114, the remote computing resource(s) 104 may make inferences from the sporting event data 114 and/or generate additional data for outputting the haptics using the sporting event data 114.

In some instances, the remote computing resource(s) 104 may filter the sporting event data 114 from the data service(s) 112 based on the haptics to be output. As an example, the sporting event data 114 received from the data service(s) 112 may indicate the locations of the players within the field of play. However, such information may be filtered and not output as haptics on the device 100. In some instances, the remote computing resource(s) 104 may filter the sporting event data 114 to determine the characteristic(s), the location(s), and/or the type.

The event data 118 may be used by the remote computing resource(s) 104 when determining the haptics to be output at the device 100. For example, based at least in part on the events 116 taking place, the remote computing resource(s) 104 may determine actuator(s) of the device 100 to actuate for outputting the haptics. In some instances, the remote computing resource(s) 104 may receive the sporting event data 114 in real-time and as the sporting event is taking place (e.g., live sporting event). For example, the remote computing resource(s) 104 may receive the sporting event data 114 in real-time or substantially real-time (e.g., after processing, etc.) to determine which of the actuator(s) to actuate. In some instances, the sporting event data 114 may be received by the remote computing resource(s) 104 after the occurrence of the event 116, or while the event 116 is occurring. For example, if the event 116 is associated with a pass of football from a first location to a second location, the sporting event data 114 associated with this event 116 may be received after the pass is made. Furthermore, in this example, the sporting event data 114 may indicate a location of the pass, who threw the football, a location of the catch (or drop), who caught football. However, although described as receiving the sporting event data 114 in real time, in some instances, the remote computing resource(s) 104 may receive the sporting event data 114 associated with a recorded or previous sporting event.

The remote computing resource(s) may determine which of the actuators to actuate based at least in part on the event data 118. To accurately portray the event 116 on the cover 102, the remote computing resource(s) 104 may map a location of the event 116 to certain actuator(s) of the device 100. For example, based at least in part on the location of the event 116, the remote computing resource(s) 104 may determine actuator(s) of the device 100 to actuate to output the haptics, where the actuator(s) that are selected are based on a location of the actuator(s) within the device 100. For example, continuing with the above example of a pass between two locations on the football field, the remote computing resource(s) 104 may determine those actuator(s) that are disposed beneath, adjacent to, etc., a throwing location of the pass and a catching location of the pass. Therein, the actuator(s) beneath the passing and throwing location may be caused to actuate, sequentially, to indicate an event. In some instances, the actuator(s) beneath or associated with the throwing location may actuate at a first instance in time and the actuator(s) beneath or associated with catching location may actuate at a second instance in time that is at least partially after the first instance in time. This haptic may be used to indicate a trajectory (or start to finish) of the pass. The actuator(s) may be controlled to sequentially output haptic(s) on the device 100.

In some instances the remote computing resource(s) 104 may extract details from the sporting event data 114 to determine, or generate, the event data 118. For example, the remote computing resource(s) 104 may extract a location of the ball, the ball carrier, and/or the action. In some instances, extracting the location may determine coordinate positions (e.g., X and Y) associated with the ball, the ball carrier, and/or the action within the field of play. The remote computing resource(s) 104 may also extract details of the event 116, such as whether the event 116 was a scoring play, a field, goal, etc., a type of the event 116 (e.g., run, pass, etc.), whether the event 116 was a tackle (e.g., contact, downed player, etc.), whether the event 116 was a turnover (e.g., fumble, interception, turnover on downs, etc.). After extracting the details of the event 116, the remote computing resource(s) 104 may process the details into haptics.

The device 100 may include any number of the actuators and/or the actuators may be individually or collectively actuated to provide haptic outputs. In some instances, locations of the event(s) 116 may be mapped to a nearest actuator of the device 100. For example, while an event may occur at a particular location within an actual field of play, given the inherent limitation of the number of actuator(s), the exact location of the event 116 may not be replicated on the device 100. Instead, using the location of the event 116, actuator(s) that are located nearest or adjacent to the location may be actuated.

In some instances, when a particular location is identified for a haptic output, actuators may be activated to various degrees of intensity. For example, when an event occurs at a particular location, the actuators may not map directly to the point and/or multiple actuators may be actuated to provide haptics at the location (or adjacent to the location). To provide for different effects of the haptic output, the degree of activation may be based at least in part on the distance of each actuator to the location of the event. In some instances, the degree of activation may be calculated as 100%—distance. In this way, when an event moves across the cover 102 by a distance that is less than the width of the actuator, a change in vibration may still be felt.

In some instances, a blending profile may be used to output haptics. For example, specific events or actions may be assigned to a specific profile of blending, that defines how the blending operation takes place. This profile may define a specific shape for the haptics output. A profile may indicate that vibration should occur in a circular pattern around the location of the event. Another profile may indicate that vibration should occur in a square shape, a ring shape, or an arrow shape, and shapes may be made to be different sizes. Profiles may also indicate different patterns of intensity. For example, one profile may have a circular pattern in which only the actuators closest to the center are actuated with a high intensity, with the intensity falling off towards the edges of the circle. Another profile may call for the same circular shape of pattern, but with the intensity being at a minimum in the center of the circle, and increasing towards the edges. These profiles may be used to generate identifiable feeling vibrations for specific events. Additionally, aspects of the profile may be modified by data. For example, if a circular profile is applied to follow the ball location, the radius of the circle may correspond to the speed of the ball such that the circle gets larger while the ball is moving quickly.

In some instances, the cover 102 may be designed such that certain positions on a field of play, such as the endzone in football, the bases in baseball, the free throw line in basketball, etc. are disposed directly on top of the actuator(s). For example, an actuator may be disposed directly beneath each base in baseball. However, in some instances, the device 100 may not have actuator(s) that are positioned at an exact location associated with an event 116. In this instance, the remote computing resource(s) 104 may determine actuator(s) that are located adjacent to the exact location of the event 116 for causing those actuator(s) to actuate. With an increase in the number of actuator(s), the fidelity of the outputs may be more accurately aligned with the exact location of the event.

In some instances, the remote computing resource(s) 104 include a mapping component 120 that maps locations of the events 116 in the sporting event to locations on the cover 102, or those actuator(s) that are disposed adjacent to the locations on the cover 102. Map data 122 may be used to determine the locations of the actuator(s) beneath the cover 102, or where the actuator(s) map to on a field of play on the cover 102. Each of the actuator(s) may output haptics at predetermined locations on the cover 102, and such locations may be known and usable by the remote computing resource(s) 104 when controlling the haptics to be output. In some instances, the actuator(s) may be arranged in a grid or array like fashion beneath the cover 102. Knowing the locations of the actuator(s), and the locations associated with the events 116, permits the remote computing resource(s) 104 to associate the events 116 with certain locations on the cover 102 for actuating the actuator(s).

As will be explained herein, in some instances, the device 100 may include interchangeable covers. The interchangeable covers may permit the device 100 to be used across a plurality of sporting events, such as football, hockey, baseball, soccer, tennis, basketball, and so forth. In some instances, the covers 102 may be interchangeable depending upon the sporting event, or the type of sporting event the device 100 is configured to accommodate. Depending upon the cover 102 installed on the device 100, certain actuator(s) may be enabled and disabled, or capable of being activated. For example, football may utilize more actuators than baseball given the size and shape of the field of play. The device 100 may be configured to recognize the cover 102, and in response, permit certain actuator(s) to be activated or permit certain actuator(s) to be deactivated. In some instances, cover data 124 may be generated by the device 100 and transmitted to the remote computing resource(s) 104 to know which cover 102 is coupled to the device 100 or which sporting event the cover 102 is associated with. Based at least in part on the cover data 124, the remote computing resource(s) 104 may determine the map data 122 associated with the cover 102.

For example, for a cover that includes a football field, a particular actuator may be associated with an area adjacent to the ten-yard line. If the cover for the football field is interchanged with a cover that includes a baseball diamond, the particular actuator may be associated with an area adjacent to third base. As such, based at least in part on the cover 102 coupled to the device 100, the mapping component 120 may determine the locations of the actuators relative to locations, areas, etc., on the field of play. In turn, this mapping, as represented within the map data 122, may be used when determining which of the actuator(s) to actuate to output the haptics.

Moreover, for different covers, different actuator(s) may be actuatable depending upon the field of play (e.g., shape, size, etc.). The respective covers may have tactile features that indicate, for example, fields of play, yard lines, court lines, free-throw lines, etc., that situate the user on the cover 1020. The cover data 124 may indicate areas on the cover 102 in which the haptics are to be output (e.g., within a field of play) and areas on the cover 102 in which haptics are not to be output (e.g., outside a field of play). In some instances, the device 100 may determine the cover 102 installed on the device 100, and transmit an indication of such to the remote computing resource(s) 104 for use to determine which of the actuators to actuate, or which of the actuators are capable of being actuated. In some instances, RFID, pin connections, etc., may be used to determine the cover 102 coupled to the device 100.

The remote computing resource(s) 104 may store or have access to region(s) 126, where the region(s) 126 indicate portions of the cover 102 in which haptics are capable of being output. For example, as indicated above, less than an entirety of the cover 102 may be associated with outputting haptics. The region(s) 126 may indicate those regions, sections, areas, etc., of the cover 102 in which the haptics may be output. As an example, the region(s) 126 may be associated with a field of play, a strike zone, a net, scores, timing, players, roster, analytics (e.g., player, game, etc.), etc. In some instances, those actuator(s) within the region(s) 126 may be capable of being actuated, while those actuator(s) outside the region(s) 126 may be restricted from being actuated.

The remote computing resource(s) 104 may determine setting(s) 128 of the actuators, such as intensities, fidelities, periods of time, frequencies, etc., when outputting the haptics. The setting(s) 128 may be determined based at least in part on the event data 118, such as the characteristic(s) of the event 116, a type of the event 116, etc. For example, whether a pass was caught, dropped, etc., may be associated with different haptics. Moreover, whether a pass was a touchdown, for example, may be associated with different haptics. Here, different events 116 may be associated with, or characterized by, different haptics output by the device 100. The setting(s) 128 may indicate when the actuator(s) actuate, for how long the actuator(s) actuate, how intense the actuator(s) actuate, sequences of the actuator(s) when actuating, etc.

In some instances, the remote computing resource(s) 104 may characterize (e.g., classify, label, etc.) the events 116 referenced within the sporting event data 114 to determine the setting(s) 128. In some instances, the setting(s) 128 may be determined using a haptic language, whereby the haptic language translates the sporting event data 114 into haptics output on the device 100. For example, the remote computing resource(s) 104 may characterize an event 116 as a pass, run, tackle, touchdown, etc., and each of the events 116 may be assigned a unique identifier of the haptic language. The haptic language may identify, for different events 116, the haptics to be output. Different events 116 may be associated with different haptics, and the unique identifier may indicate the haptics for the different events 116. In this manner, the haptics output for a tackle, catch, pass, etc., in football may be different from one another. The haptic language may identify the setting(s) 128 associated with each of the event(s).

Moreover, although the discussion is described herein with regard to the remote computing resource(s) determining the haptics, the actuator(s) to actuate, the setting(s) 128, etc., the device 100 may itself, in some instances, determine which actuator(s) to actuate, the setting(s) 128 by which the actuator(s) actuate, and so forth. Any level of split processing may be employed between the device, the remote computing resource(s), the data service(s) 112, and/or other systems, devices, etc.

Once the remote computing resource(s) 104 determines the actuator(s) to actuate and the setting(s) 128 associated with such actuation, the remote computing resource(s) 104 may generate haptic data 130 and communicate with the device 100. In some instances, the device 100 may receive the haptic data 130, which is indicative of instructions, commands, etc., from the remote computing resource(s) 104 as to which of the actuator(s) are to be actuated and the setting(s) 128 of the actuator(s) for adjusting the haptics to be output (e.g., intensities, fidelities, periods of time, frequencies, etc.). Responsive to receiving the haptic data 130 from the remote computing resource(s) 104, the device 100 may cause the actuator(s) to actuate according to the setting(s) 128.

Other data, however, may be received by and output by the device 100, such as a score, timing (e.g. inning, period, etc.), an indication of a player associated with the event 116, etc. The device 100 may continuously receive the haptic data 130, or other data, from the remote computing resource(s) 104 to allow the user to follow along, play-by-play, etc. By sequencing and varying the intensity, duration, and density of the haptics output by the actuator(s) over time, the device 100 is able to animate haptics and intuitively communicate spatial details through touch about the sporting event.

As an example event 116, consider that during a football game a pass is completed as a score in the endzone. In some instances, the remote computing resource(s) 104 may receive the sporting event data 114 after completion of the pass. The pass, in this example, may be from the thirty-yard line to the endzone. The pass may also occur at a particular hashmark on the thirty-yard line (e.g., laterally across the field). Upon receiving the sporting event data 114, the remote computing resource(s) 104 may determine a location on the field at which the football was thrown and a location on the field at which the football was caught. Knowing these locations, the remote computing resource(s) 104 may determine those actuator(s) that are associated with the throwing location and those actuator(s) that are associated with the catching location. The actuator(s) at the throwing location may actuate to a first frequency or vibration, while the actuator(s) at the catching location may actuate to a second frequency or vibration, thereby portraying contextual information to the user. These may be stored as setting(s) 128. The remote computing resource(s) 104 may therein communicate with the device 100, whereby the device 100 may cause the actuator(s) at the throwing location to vibrate at a first instance in time, and then cause the actuator(s) at the catching location to vibrate at a second instance in time. This allows the user to track the location of the football during the throw.

In some instances, audio may be output on the device 100 associated with the sporting event. In some instances, the remote computing resource(s) 104 may include an audio component 132 that generates audio data 134 associated with the events 116. The audio data 134 may be generated after, or while, the events 116 are characterized. For example, knowing specifics of the event 116, the audio component 132 may determine words, phrases, etc., to output in association with the haptics. In some instances, the audio data 134 may be generated by the remote computing resource(s) 104 to annotate the events 116. For example, when the remote computing resource(s) 104 determine that an event 116 associated with a pass has occurred, the remote computing resource(s) 104 may generate audio data indicating the pass, a location of the pass, a flight of the pass, who the pass is intended for, etc. Alternatively, in some instances, the device 100 itself may generate the audio data 134. As part of generating the audio data 134, the device 100 may utilize the sporting event data 114, data received from the remote computing resource(s) 104, etc.

In some instances, the remote computing resource(s) 104 may leverage artificial intelligence (AI) or machine-learning (ML) model(s) to generate the audio data 134. For example, Al may be used to create data-generated broadcast commentary that may be synchronized with the device 100, and customized to the desire of the user. By leveraging AI language models, AI voice generators, and datasets, users may personalize their experience. For example, some users might choose to have commentary that focuses on gameplay strategy, while others may prefer commentary that explains the sporting event (e.g., rules, scoring, etc.).

In some instances, the audio output at the device 100 may be synchronized with the haptics output by the actuators. In some instances, the audio may be delayed (e.g., via a buffer) to synchronize the audio with the haptics being output. For example, as the sporting event is taking place in real-time, the sporting event data 114 may be generated at a delay. In turn, the sporting event data 114 received from the remote computing resource(s) 104 may be received at a delay as compared to the audio (which may include a lesser delay). In some instances, time stamps may be used to output the haptics and the audio synchronously.

In some instances, the user may have the ability to configure the device 100 according to certain preference(s). The preference(s) may be stored in association with a profile 136 of the user, where the preference(s) may be used by the remote computing resource(s) 104 and/or the device 100 when outputting the haptics, audio, etc. In some instances, the user may indicate the types of events 116 to be output on the device 100, the setting(s) 128 of the actuator(s), the events 116 associated with certain players, etc. As an example, the user may define the setting(s) 128 for an intensity of haptics for a catch, as compared to a run, in football. As another example, the user may prefer to only have haptics for passes that are caught, as compared to passes that are incomplete or dropped. As another example, a user may prefer to receive events that are associated with a certain player. The preference(s) or other data stored in association with the profile 136, may be used by the remote computing resource(s) 104 when filtering the sporting event data 114 from the data service(s) 112 or when determining the event data 118.

The remote computing resource(s) 104 may communicate with any number of the devices 100 for outputting haptics. For example, within an arena, stadium, sporting event venue, etc., there may be any number of devices 100 used across users. In some instances, the devices may be loaned, rented, sold, etc., at a sporting event for use by the users. For each of the devices 100 and across different sporting events, the devices 100 may output haptics for different users (e.g., based on their preference(s)). In some instances, the remote computing resource(s) 104 may have access to device identifier(s) 138 to permit communication with particular devices.

In some instances, the remote computing resource(s) 104 and/or the device 100 may communicatively couple to a mobile device 140 (e.g., phone, tablet, computer, wireless headphones, etc.). In some instances, for example, when the mobile device 140 is a phone, the remote computing resource(s) 104 may communicate with the mobile device 140 and in turn, the mobile device 140 may communicate with the device 100 for outputting the haptics, audio, etc. The mobile device 140 may act as an intermediary between the device 100 and the remote computing resource(s) 104, or the device 100 and other devices on the network(s) 106. In some instances, the device 100 may be powered via the mobile device 140 (e.g., cords, cables, etc.), for example, to actuate the actuator(s).

The network(s) 106 may be representative of any network, including data and/or voice network, and may be implemented using wired infrastructure (e.g., cable, CAT5, fiber optic cable, etc.), a wireless infrastructure (e.g., RF, cellular, microwave, satellite, Bluetooth, 5G, etc.), and/or other connection technologies. The device, the remote computing resource(s) 104, the mobile device 140, etc., may include suitable network interface(s) to communicate over the network(s) 106.

In some instances, the remote computing resource(s) 104 may be implemented as one or more servers and may, in some instances, form a portion of a network-accessible computing platform implemented as a computing infrastructure of processors, storage, software, data access, etc. that is maintained and accessible via a network such as the Internet. The remote computing resource(s) 104 does not require end-user knowledge of the physical location and configuration of the system that delivers the services. Common expressions associated with the remote computing resource(s) 104 may include “on-demand computing”, “software as a service (SaaS)”, “platform computing”, “network-accessible platform”, “cloud services”, “data centers”, etc. However, in some instances, the remote computing resource(s) 104 may be located within a same environment or different environment as the device 100.

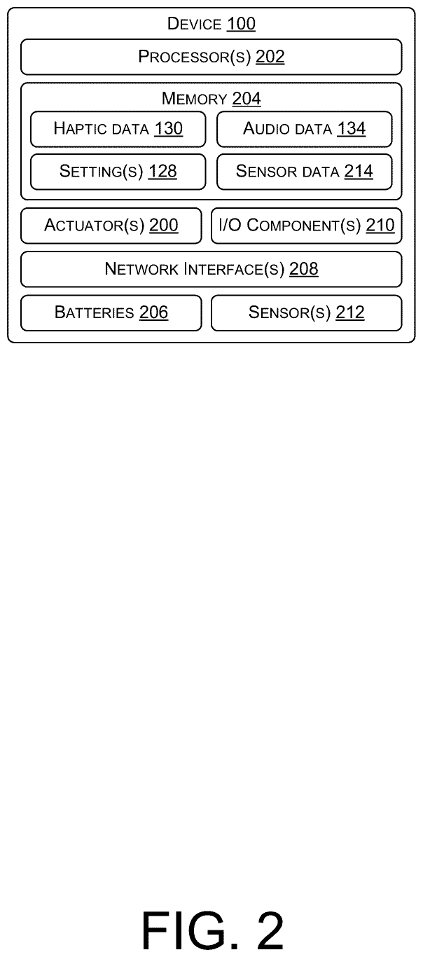

FIG. 2 illustrates select components of the device 100, according to examples of the present disclosure. The device 100 includes actuator(s) 200 that are actuated to vibrate and output haptics on the cover 102. In some instances, the actuator(s) 200 may actuate (e.g., fire) in a direction towards the cover 102 to engage the cover 102 (e.g., a bottom surface of the cover 102). In some instances, foam, rubber, silicone, etc., may be disposed between an interface of the actuator(s) 200 and the cover 102. In some instances, each of the actuator(s) 200 may be adhered onto a piece of foam, padding, fabrics, etc. (e.g., silicone, etc.) to dampen vibrations from the actuator(s) 200 and prevent the vibrations moving throughout an entirety of the device 100, different areas of the cover 102, a PCB to which the actuator(s) 200 are mounted, etc. In this manner, haptics may be localized adjacent to the actuator(s) 200 that are being actuated. This has the effect on limiting the haptics to certain areas on the cover 102 to convey spatial information to the user, as compared to the haptics propagating throughout or be imparted to an entirety of the cover 102 In some instances, the actuator(s) 200 may be engaged with a bottom of the cover 102 and, when actuated, may output the haptics through the cover 102. Alternatively, the actuator(s) 200 may initially be disengaged with the bottom of the cover 102, and when actuated, may become engaged with the cover 102 to output the haptics.

In some instances, the actuator(s) 200 may include linear resonant actuators (LRA). However, other types of actuator(s) 200 may be used, such as eccentric rotating mass (ERM) actuators, coin vibration ERM actuators, ultrasonic actuators, PCB linear actuators, etc. Any combination of the actuator(s) 200 may be used. In some instances, the actuator(s) 200 may be arranged in a grid-like fashion within the device 100. In some instances, the actuator(s) 200 may be arranged as a rectangular, square, circle, or any other shape within the device 100. The number of the actuator(s) 200 used within the device 100 may permit different levels of granularity of the haptics being output. For example, including more of the actuator(s) 200 may permit a greater fidelity to represent a sporting event being portrayed on the device 100.

In some instances, the actuator(s) 200 may be individually or collectively actuated. In some instances, whether the actuator(s) 200 are individually or collectively controlled may be based at least in part on the event 116, such as a type of the event 116, the haptic language of the event 116, etc. In some instances, the actuator(s) 200 may be individually controlled to describe the location of the ball, for example, and the actions of the player who possesses the ball (e.g., run, pass, catch, drop, etc.). The actuator(s) 200 may be collectively controlled to describe significant or powerful events and regional occurrences (e.g., tackle, touchdown, etc.).

In some instances, the device 100 may include 192 actuators arranged in an 8×24 grid, 288 actuators arranged in a 12×24 grid, 640 actuators arranged in a 40×16 grid, or 512 actuators arranged in a 32×16 grid. However, although a particular number of the actuator(s) 200 are described, a different amount of the actuator(s) 200 may be included. In some instances, a density of the actuator(s) 200 may be the same across the device 100 or the cover 102, and/or different areas of the device 100 may have a greater density of the actuator(s) 200. Moreover, the actuator(s) 200 may be similarly or differently sized compared to one another.

In some instances, although the device 100 includes a predetermined number of the actuators, depending upon the sporting event being portrayed on the device 100 or a configuration of the device 100, such as the cover 102 coupled to the device 100, not all of the actuator(s) 200 may be actuatable. For example, the number of the actuator(s) 200 disposed in the device 100 may accommodate different sporting events. However, depending upon the sporting event being portrayed at a particular instance in time by the device 100, not all of the actuator(s) 200 may be actuatable to output the haptics. For example, football, because of the large field of play, may use more of the actuators than a smaller field of play, such as basketball.

In some instances, the actuator(s) 200 may be associated with respective positions on or beneath the cover 102, or more specifically, certain locations within or outside a field of play (e.g., out of bounds, sidelines, endzones, etc.) as represented on the cover 102. The locations of the actuator(s) 200 beneath the cover 102 may be known and such locations may be used when determining which of the actuator(s) 200 to actuate when outputting the haptics. The map data 122 may indicate such locations. As such, the actuator(s) 200 may be mapped to or associated with certain locations on the cover 102, and using the location of the actuator(s) 200, the actuator(s) 200 may be respectively actuated to represent events occurring during the sporting event.

The device 100 is shown including processor(s) 202 and memory 204, where the processor(s) 202 may perform various functions and operations associated with outputting haptics at the device 100, and the memory 204 may store instructions executable by the processor(s) 202 to perform the operations described herein. The device 100 may communicatively couple to the remote computing resource(s) 104, for example, to receive the haptic data 130 and/or the setting(s) 128 associated with controlling the actuator(s) 200. Responsive to receive the haptic data 130 and/or the setting(s) 128, the device 100 may cause certain actuator(s) 200 to actuate based on the setting(s) 128.

As noted above, the device 100 may output audio associated with the sporting event. While touch may convey spatial details about the sporting event, audio commentary may convey emotion, explains strategy, and highlights key contextual information about the sporting event. In some instances, the device 100 may receive the audio data 134 from the remote computing resource(s) 104, other devices (e.g., radio, TV broadcasts), etc. The audio data 134 may be output in association with, and coordinated with, output of the haptics. For example, the device 100 may include a speaker or audio jack for headphones that outputs audio associated with the sporting events. In some instances, the audio data 134 may indicate the events 116 taking place, the players involved, commentary from broadcasters, and so forth.

The device 100 may include suitable computing and hardware components that permit outputs of the haptics, audio, etc. For example, the device 100 may include batteries 206, network interface(s) 208 (e.g., Wireless, Cellular, Bluetooth, etc.), heat-dissipating elements, shielding foams, input/output I/O components 210 (e.g., buttons, switches, speaker(s), touchpad, etc.), sensor(s) (e.g., microphone(s), accelerometers, etc.). Buttons, for example, may be disposed on the device 100 and/or the cover 102. In some instances, the I/O component(s) 210 may be used to control one or more operations associated with the device 100, such as powering on and off the device 100, selecting a sporting event, outputting audio, etc. The network interface(s) 208 permit the device 100 to communicate with the remote computing resource(s) 104, the mobile device 140, and/or other devices, such as wireless headphones for outputting audio associated with the sporting event.

The device 100 may, in some instances, include sensor(s) 212 disposed beneath or integrated within the cover 102. The sensor(s) 212 may track a location of the user on the cover 102, such as a location of a placement of their hands, fingers, etc. In some instances, the location of the user may be used to provide outputs to correct the user as to the placement of their hands. Moreover, the sensor(s) 212 may be used to determine an amount of force the user presses against the cover 102 to feel the haptics. Sensor data 214 generated by the sensor(s) 212 may be used to control haptics, such as increasing or decreasing an intensity of the actuator(s) 200, an amount of time the actuator(s) 200 vibrate, etc. Examples of the sensor(s) 212 may include proximity sensor(s), capacitive sensor(s), resistive sensor(s), etc.

As used herein, a processor, such as the processor(s) 108 and/or the processor(s) 202 may include multiple processors and/or a processor having multiple cores. Further, the processor(s) 108 and/or the processor(s) 202 may comprise one or more cores of different types. For example, the processor(s) 108 and/or the processor(s) 202 may include application processor units, graphic processing units, and so forth. In one implementation, the processor(s) 108 and/or the processor(s) 202 may comprise a microcontroller and/or a microprocessor. The processor(s) 108 and/or the processor(s) 202 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 108 and/or the processor(s) 202 may possess its own local memory, which also may store program components, program data, and/or one or more operating systems.

Memory, such as the memory 110 and/or the memory 204 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 108 and/or the processor(s) 202. The memory 110 and/or the memory 204 is an example of non-transitory computer-readable media. The memory 110 and/or the memory 204 may store an operating system and one or more software applications, instructions, programs, and/or data to implement the methods described herein and the functions attributed to the various systems.

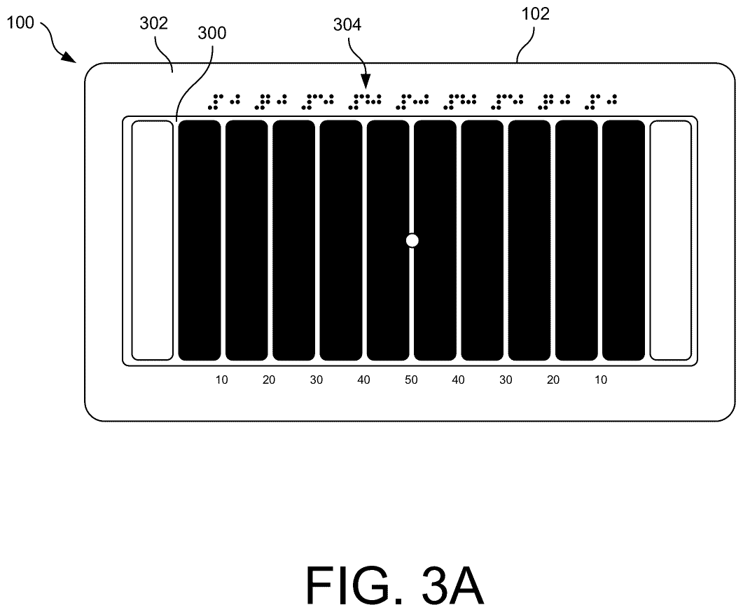

FIGS. 3A-3C illustrate details of the cover 102, according to examples of the present disclosure. In some instances, the cover 102 may include different regions, interfaces, sections, etc., that output different information associated with the sporting event. For example, different region(s) 126 may output different haptics.

The cover 102 provides an interface (e.g., surface) where the user places their hand(s). In some instances, the cover 102 may also include tactile features 300, such as court lines, fields of play, strike zones, yard lines, or other indicators. In some instances, the tactile features 300 may be embossed or debossed on the cover 102, such as a top surface 302 of the cover 102, thereby providing feedback to the user regarding the placement of their hand(s) within or on a field of play, for example. The tactile features 300 may also assist the user in positioning, locating, etc., their hands on the device 100 and orienting the user on the device 100. The cover 102 may include any number of indicators (e.g., 10-yard line in football) and/or braille translations associated. The tactile features 300 may also include different surface finishes, textures, etc., to assist the user in orienting themselves on the cover 102 and/or understanding the events 116 on the cover 102. For example, different areas of the cover 102 may include different textures and/or surface finishes to indicate an endzone, as an example. The cover 102 may also include braille characters 304 indicative of locations, areas, spots, references, points, etc., on the field of play.

In some instances, the device 100 may include a charging port 306 (e.g., USB-C) for charging the batteries 206 of the device 100. Although the device 100 and/or the cover 102 is shown as being rectangular in shape, other shapes are envisioned. In some instances, the cover 102 may be planar. Additionally, the cover 102 may include a curved (e.g., pillowed) surface. The curved surface may improve wrist posture or increase a surface area of the hands (e.g., palms, fingers, etc.) in contact with the cover 102 (e.g., given the curvature of the hand). For example, the curved surface may be more form-fitting to the natural position of the hand.

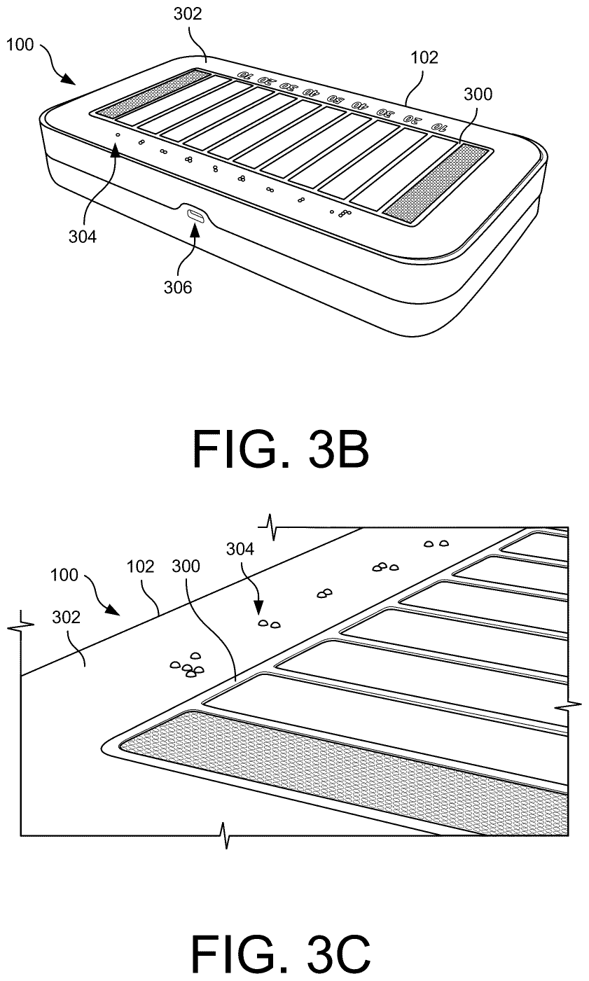

FIG. 4A illustrates an exploded view of the device 100, according to examples of the present disclosure.

The device 100 includes one or more housings 400, such as a first housing 400(1) and a second housing 400(2). In some instances, the first housing 400(1) and the second housing 400(2) couple together (e.g., via fasteners). The first housing 400(1) may define a first cavity 402 in which one or more components of the device 100 reside. For example, a controller 404, the network interface(s) 208 (e.g., 5G), and the batteries 206 may reside within the first cavity 402. In some instances, a shroud 406 may be disposed over components disposed within the first cavity 402, such as the batteries 206.

The device 100 includes a PCB 408 which, in some instances, is disposed within a second cavity 410 of the second housing 400(2). Alternatively, the PCB 408 may be disposed within the first cavity 402. In some instances, the actuator(s) 200 are coupled to, disposed on, etc., the PCB 408. Additionally, or alternatively, a mount 412 may be used to orient, position, locate, etc., the actuator(s) 200 within the device 100. For example, the mount 412 may include a plurality of receptacles 414 in which the actuator(s) 200 are at least partially disposed. Although not shown, foam, membranes, etc., may be disposed over, underneath, etc., the actuator(s) 200.

In some instances, the device 100 may include multiple PCBs. For example, the device 100 may include a first PCB on which the actuator(s) 200 are disposed and a second PCB that includes computing components (e.g., processor(s), memory, network interface(s), etc.). The use of multiple PBCs may prevent vibrations adversely impacting other computing components of the device 100. The use of multiple PBCs may also reduce manufacturing times.

The device 100 includes the cover 102. In some instances, the cover 102 couples to a frame 416, whereby the frame 416 may couple to the second housing 400(2). In some instances, the cover 102 and the frame 416 may be integrated as a single component, or the cover 102 may couple to the frame 416 for coupling to the other components of the device 100 (e.g., the second housing 400(2)). Introduced above, the cover 102 may be interchanged with other covers. In some instances, the cover 102 and the frame 416 may be interchanged with one another, as an assembly, or the cover 102 may removably couple to the frame 416, and therein, another cover may couple to the frame 416. Although described as including two housings, the device 100 may include more than or less than two of the housings. For example, the device 100 may include a single housing that is enclosed via the cover 102.

In some instances, the cover 102 may couple to the frame 416, for example, via fasteners, snap-fits, key/keyways, or other male/female connectors. In some instances, the cover 102 may couple to the frame 416 or the second housing 400(2), or more generally, the device 100, via attachment mechanisms that slidably engage with one another. For example, the cover 102 may include first attachment mechanisms that slidably engage with second attachment mechanisms on the frame 416 or the second housing 400(2). The first attachment mechanisms and the second attachment mechanisms may disengage (e.g., via sliding in an opposite direction) to permit the cover 102 to be interchanged. In other instances, the cover 102 may rest on the frame 416 or the second housing 400(2), be secured to the frame 416 or second housing 400(2) via magnetic elements, etc.

FIG. 4B illustrates an exploded view of an alternative device 418, according to examples of the present disclosure. The device 418 may be similar to the device 100 and include similar components for outputting haptics on a cover 420. However, the device 418 may include a single housing, such as a housing 422, as compared to the first housing 400(1) and the second housing 400(2). Components of the device 418 may be disposed within a compartment 424 of the housing 422. The actuator(s) 200 may be disposed on a PCB 426, which may be similar to the PCB 408. A plate 428 may be disposed between the PCB 426 and the cover 420. The plate 428 may have a first cavity 430 through which the actuator(s) 200 are disposed for engaging with a bottom surface of the cover 420. Moreover, the plate 428 may have a second cavity 432 that accommodates buttons 434 on the cover 420. For example, connections may be disposed between the buttons 434 and the PCB 426, through the first cavity 430. As also shown, the cover 420 may include a first region 436 corresponding to a field of play for baseball, and a second region 438 corresponding to a strike zone for baseball. Certain areas within the second region 438 (e.g., zones of the strike zone) may output haptics associated with pitches.

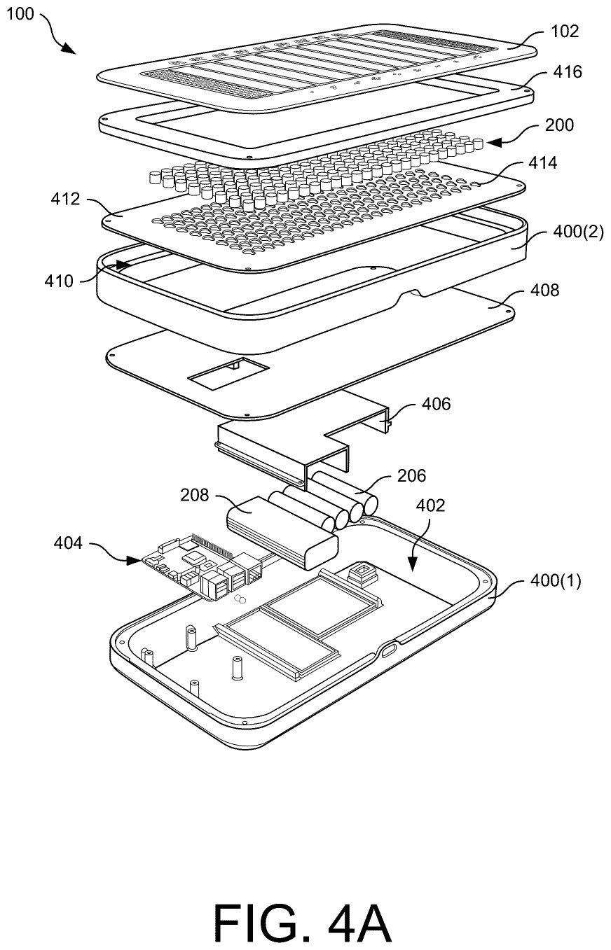

FIG. 5 illustrates the actuator(s) 200 disposed on the PCB 408, according to examples of the present disclosure. In some instances, foam, padding, etc., may be disposed between the actuator(s) 200 and the PCB 408 to localize and/or reduce vibrations. For example, foam 502 may be disposed between the actuators 200 and the PCB 408. In some instances, a membrane 500 may be disposed over the actuator(s) 200 to protect the actuator(s) 200 from debris, dust, liquid, etc. In FIG. 5, the membrane 500 is shown being pulled back from a subset of the actuator(s) 200 to illustrate the actuator(s) 200 coupled to the PCB 408. The membrane 500 may include cavities, pockets, etc., that are disposed over the actuator(s) 200. The membrane 500 may engage with a bottom surface of the cover 102, opposite the top surface 302 of the cover 102 that includes the tactile features 300.

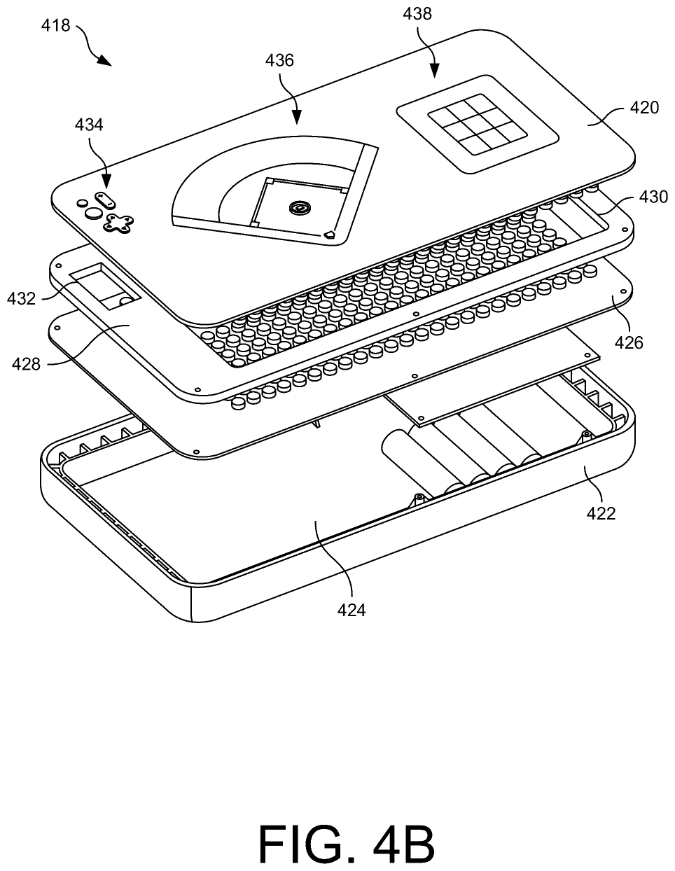

FIG. 6 illustrates an example sequence of haptics that are output by the device 100, according to examples of the present disclosure. In FIG. 6, the cover 102 is shown being associated with football, however, haptics may be output in association with other sporting events, games, etc., that are taking place. In FIG. 6 a sequence of three events 116 is shown taking place. For each of the events 116 taking place, the remote computing resource(s) 104 may receive the sporting event data 114 and then translate the sporting event data 114 into haptics that are output on the device 100.

At “1” in FIG. 6, a first event may be output on the device 100. For example, the first event may be associated with a run of a football from the 49 yard-line to the 45 yard-line. For the first event, the remote computing resource(s) 104 may receive the sporting event data 114, determine that the event 116 is associated with a run, determine the yard-lines over which the run occurred, and so forth. The sporting event data 114 may be received after the event 116 has occurred during the sporting event. In some instances, the remote computing resource(s) 104 may, after determining the event 116 is a run, translate the event into haptics via haptic language. For example, a run may include a first intensity, first duration, etc., at which to output the haptics. The remote computing resource(s) 104 also determine, using the locations associated with the run, the corresponding actuator(s) 200 to actuate to output the haptics. As such, at “1” in FIG. 6, the device 100 may output a first haptic 600 associated with a beginning of the run and output a second haptic 602 associated with an end of the run. The first haptic 600 may be output at a first instance in time and the second haptic 602 may be output at a second instance in time that is after the first instance in time.

At “2” in FIG. 6, a second event may be output on the device 100. For example, the second event may be associated with a run of a football from the forty-five yard-line to the thirty-yard line. For the second event, the remote computing resource(s) 104 may receive the sporting event data 114, determine that the event 116 is associated with a run, determine the yard-lines over which the run occurred, and so forth. The sporting event data 114 may be received after the event 116 has occurred during the sporting event. Moreover, the sporting event data 114 associated with the second event may be received after the sporting event data 114 associated with the first event. In some instances, the remote computing resource(s) 104 may, after determining the event 116 is a run, may use a haptic language when determining the haptics to output. For example, a run may include a first intensity, first duration, etc., which to output the haptics. In this sense, because the first event and the second event are associated with a same type of event 116 (i.e., a run), the haptics associated with the first event and the second event may be similar. The difference, however, may be where the haptics are output on the device 100, being as the first event and the second event occur at different locations. At “2” in FIG. 6, the device 100 may output a third haptic 604 associated with a beginning of the run and output a fourth haptic 606 associated with an end of the run. The third haptic 604 may be output at a third instance in time that is after the second instance in time. The fourth haptic 606 may be output at a fourth instance in time that is after the third instance in time.

Although described that the haptics associated with the first event and the second event may be similar, consider that a tackle associated with the first event is of a greater intensity (e.g., force) than a tackle associated with the second event. For example, the player associated with the first event may be tackled harder than the player associated with the second event. In such instances, the second haptic 602 may have a greater intensity than the fourth haptic 606 to indicate that the tackle was more severe, with more force, etc. This is just one example, and other fidelities of the haptics may provide for a more immersive experience.

At “3” in FIG. 6, a third event may be output on the device 100. For example, the third event may be associated with a pass of a football from the thirty-yard line to the endzone. For the third event, the remote computing resource(s) 104 may receive the sporting event data 114, determine that the event 116 is associated with a pass, determine the yard-lines over which the pass occurred, and so forth. The sporting event data 114 may be received after the event 116 has occurred during the sporting event. Moreover, the sporting event data 114 associated with the third event may be received after the sporting event data 114 associated with the second event. In some instances, the remote computing resource(s) 104 may, after determining the event 116 is a pass, use a haptic language when determining the haptics to output. For example, a pass may include a second intensity, second duration, etc., which to output the haptics. At “3” in FIG. 6, the device 100 may output a fifth haptic 608 associated with a passing location of the pass and output a sixth haptic 610 associated with a catching location of the pass. The fifth haptic 608 may be output at a fifth instance in time that is after the fourth instance in time. The sixth haptic 610 may be output at a sixth instance in time that is after the fifth instance in time.

In some instances, haptics may be output along a trajectory 612 of the football, between the location at which the football is thrown to the location at which the football is caught. In some instances, the remote computing resource(s) 104, using the throw location and the catch location, may determine the trajectory 612 of the football. Based on the trajectory of the football, the remote computing resource(s) 104 may determine the actuator(s) 200 to actuate to output haptics associated with the trajectory 612. This may allow the user to track the location of the football during the throw.

In some instances, the data (e.g., the haptic data 130) sent to the device 100 may indicate a timing at which to output the haptics as well as the setting(s) 128. In some instances, the sporting event data 114 associated may indicate the hash marks or specific positions along the yard-lines associated with the events 116. Moreover, the sporting event data 114 may indicate the players involved, a speed of the football, a score, a timing of the throw and/or the catch, a type of catch (e.g., diving, sliding, etc.), a type of throw (e.g., fade, loft, etc.), etc. In some instances, some or all of the sporting event data 114 received by the remote computing resource(s) 104 may be used to determine the haptics. In addition, the sporting event data 114 may indicate more than one event 116 taking place.

Moreover, although certain events are described, the device 100 may output haptics for other events 116 for football, such as sacks, tackles, interceptions, field goals, etc. The haptics for the different events may be different or similar, and determined using the haptic language that characterizes the events 116. For example, different events may be associated with different setting(s) 128.

However, in some instances, only the sixth haptic 610 may be output on the device 100 to indicate the location of the catch. Moreover, in some instances, rather than having actuator(s) 200 adjacent to the catch location output the sixth haptic 610, all of the actuator(s) 200 associated with the endzone may actuate to output the sixth haptic 610. For example, imparting haptics to a greater area of the cover 102 may provide increased fidelity and gametime experiences.

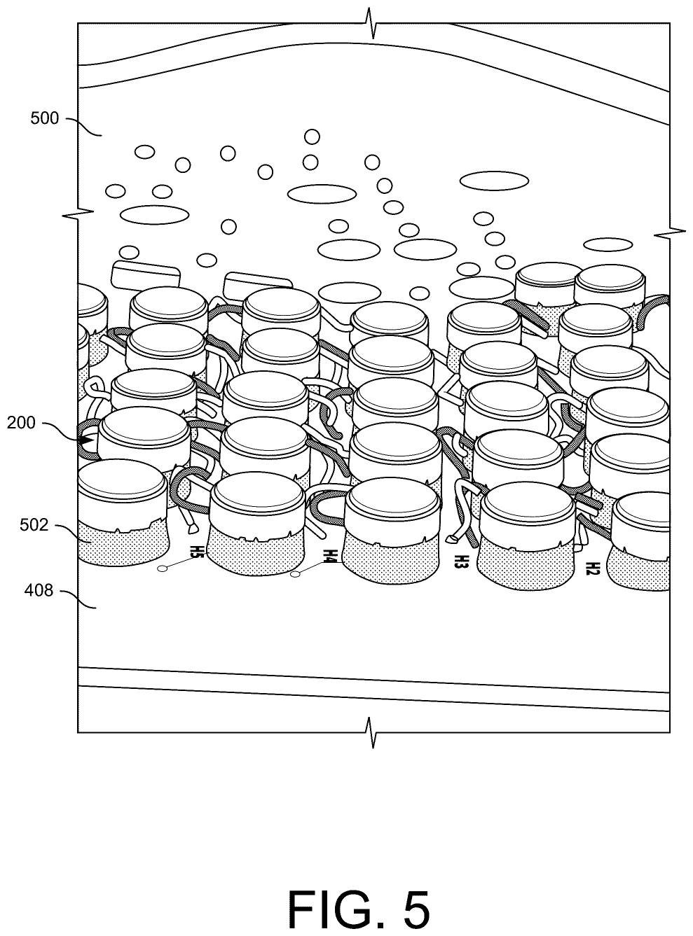

FIG. 7 illustrates an example cover 700, according to examples of the present disclosure. As shown, the cover 700 may be associated with baseball. In some instances, the cover 700 may include a first region 702 and a second region 704 associated with outputting haptics. The first region 702 may correspond to the baseball diamond (e.g., the field of play), whereas the second region 704 may correspond to a strike zone. In some instances, the user may place their left hand onto, over, etc., the first region 702 to experience where balls are hit, throws are thrown, players are out, etc. The user may place their right hand onto, over, etc., the second region 704 to experience where the pitches are thrown in the strike zone, as well as the location of balls pitched outside of the strike zone.

The baseball diamond, such as the left field line, right field line, bases (i.e., first base, second base, third base, home base/plate, pitcher's mound, etc.) may include tactile features, whether embossed or debossed into the cover 700, made of a different material that other portions of the cover 700, include a different surface finish, etc. The tactile features may assist the user in orienting themselves on the cover 700, for example, to know whether the ball was hit to left field, right field, center field, etc.

The strike zone may also include tactile features, for example, associated with the zones in the strike zone. This permits the user to understand where within the strike zone the ball was pitched. In some instances, the haptics output within the strike zone may be different for balls and/or strikes, whether the pitch was thrown at a certain velocity, whether the pitch was hit, whether the pitch was associated with a strike out, a type of the pitch (e.g., curveball, fastball, slider, knuckleball, etc.). As such, different haptics may be used to convey specifics of the pitches.

In some instances, the cover 700 may also include a third region 706 associated with a pitch count (e.g., balls and strikes) and/or the number of outs. Although not shown, additional regions may include the inning, the timing, the score, players (e.g., pitcher, at bat, etc.), and so forth. The cover 700 may also include braille translations/characters associated with the regions to convey information to the user.

In some instances, each of the first region 702, the second region 704, and/or the third region 706 may be associated with certain actuator(s) 200. The first region 702, the second region 704, and/or the third region 706 may be designed on (e.g., layout) the cover 700 to be disposed above, or coincide with, certain actuator(s) 200. In some instances, however, the actuator(s) 200 may not be disposed exactly beneath the points within the first region 702, the second region 704, and/or the third region 706, such as directly above second base, for example. In such instances, the actuator(s) 200 adjacent or closest to second base may be actuated to output haptics (e.g., in response to a double, runner stealing to second, etc.). Moreover, not all of the actuator(s) 200 may be configured to be actuated when the cover 700 couples to the device 100. For example, actuator(s) disposed between the first region 702 and the second region 704 (i.e., which are not part of the first region 702 and the second region 704) may be deactivated.

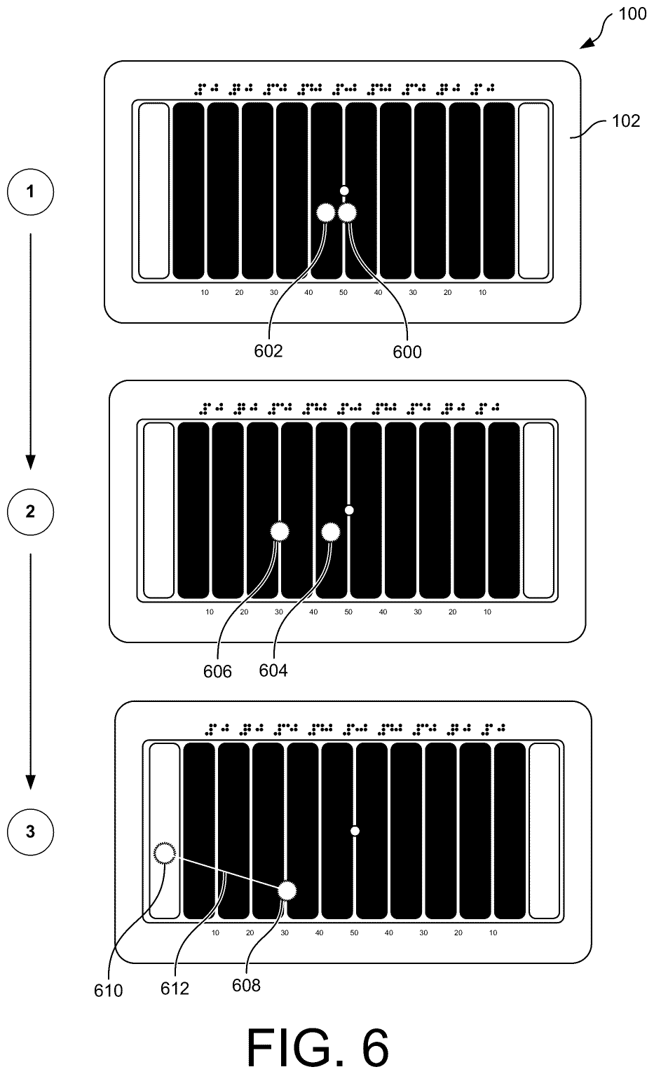

FIG. 8 illustrates an example cover 800, according to examples of the present disclosure. The cover 800 may be associated with basketball. In some instances, the cover 800 may include a region 802 associated with a basketball court. The user may place their hands onto, over, etc., the region 802 as a way to follow along with a basketball game via haptics being output.

The region 802 may include tactile features associated with a halfcourt line, the three-point lines, the keys, the out of bounds lines, the free throw lines, etc. The tactile features may assist the user in orienting themselves on the cover 800, for example, to know where the basketball is, shots that were made, shots that were missed, etc. Although not shown, additional regions may include the period, the timing, the score, players, and so forth. The cover 800 may also include braille translations associated with the regions to convey information to the user.

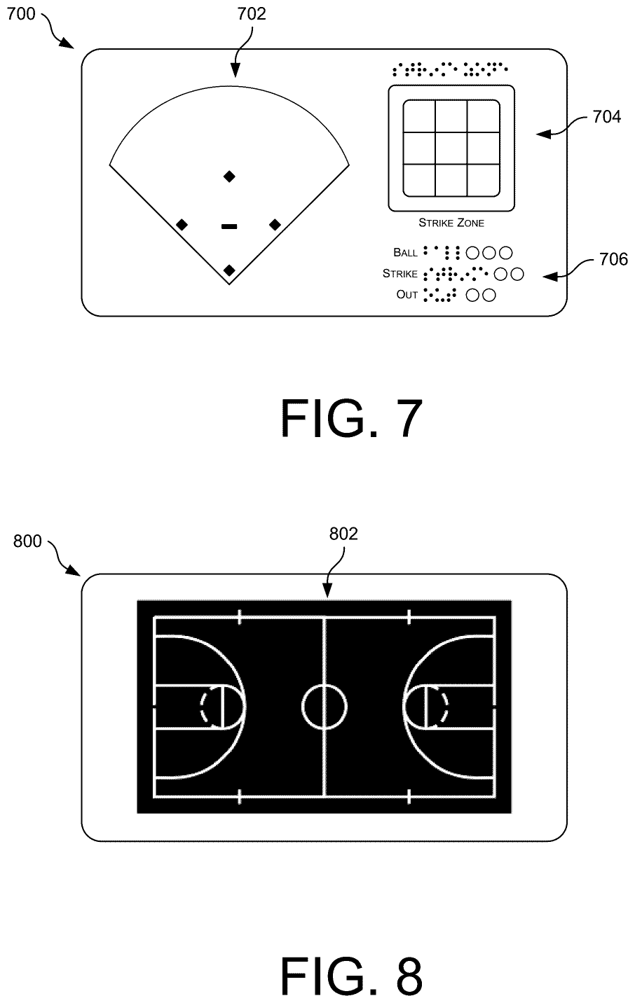

FIG. 9 illustrates an example cover 900, according to examples of the present disclosure. The cover 900 may be associated with hockey. In some instances, the cover 900 may include a first region 902 and a second region 904. The first region 902 may be associated with a hockey rink. In some instances, the user may place their right hand onto, over, etc., the first region 902 to experience where the puck moves, shots that are taken, saves, checks, offsides, icing, etc. The user may place their left hand onto, over, etc., the second region 904 to experience where shots are taken on goal.

The ice rink as represented on the cover 900 may include tactile features, whether embossed or debossed into the cover 900, made of a different material than the cover 900, include a different surface finish than the cover 900, etc. The tactile features may assist the user in orienting themselves on the cover 900. In some instances, the goal lines, the blue lines, the neutral zone, the center line, the defensive zones, the offensive zones, etc., may include tactile features. Similarly, the goal within the second region 904 may include tactile features for orienting the user on the goal to understand where shots are taken on goal. Although not shown, additional regions may include the period, the timing, the score, players, etc. The cover 900 may also include braille translations associated with the regions to convey information to the user.

The cover 900 may also include a button 906 (or switch), such as a D-pad. The button 906 may be used to control setting(s) of the device 100, such as the preference(s) stored in the profile 136, select a sporting event to experience on the device 100 (e.g., a hockey game amongst a plurality of hockey games), etc. In some instances, the button 906 may be integrated within the cover 102 and communicatively coupled to computing component(s) within the device (e.g., PCBs, etc.). Alternatively, the cover 900 may include a cap associated with the button 906, but logic, switches, etc., associated with the button 906 may be disposed beneath the cover 900. Depending upon the cover installed on the device, the button 906 may or may not be activated.

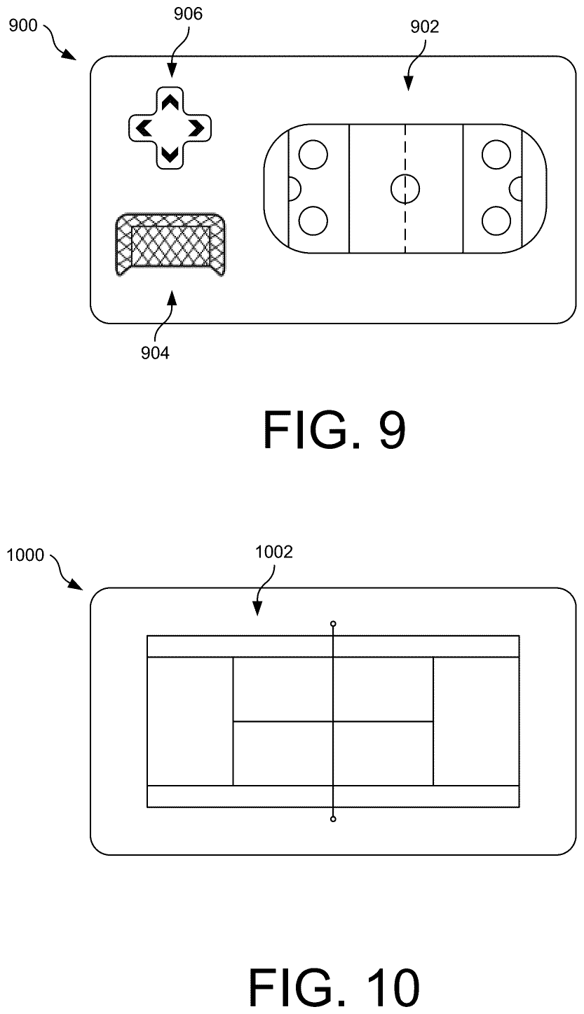

FIG. 10 illustrates an example cover 1000, according to examples of the present disclosure. The cover 1000 may be associated with tennis. In some instances, the cover 1000 may include a region 1002 associated with a tennis court. The user may place their hands onto, over, etc., the region 1002 as a way to follow along with a tennis match via haptics being output.

The region 1002 may include tactile features associated with the net, baselines, sidelines (whether singles or doubles), left and right service boxes, service line, etc. The tactile features may assist the user in orienting themselves on the cover 1000, for example, to know where the tennis ball is served, returned, etc. Although not shown, additional regions may include the timing, the score (e.g., games, sets, etc.), players, service speed, and so forth. The cover 1000 may also include braille translations associated with the regions to convey information to the user.

Although FIGS. 7-10 illustrate certain covers, other covers are envisioned. In such instances, the covers may be associated with different sporting events, games, etc. Moreover, depending upon the sporting events, covers, etc., the cover may include associated tactile features to assist the user and/or to provide further context regarding the events 116 taking place. Moreover, the covers may include regions different than those described, whereby the regions may be associated with outputting the haptics.

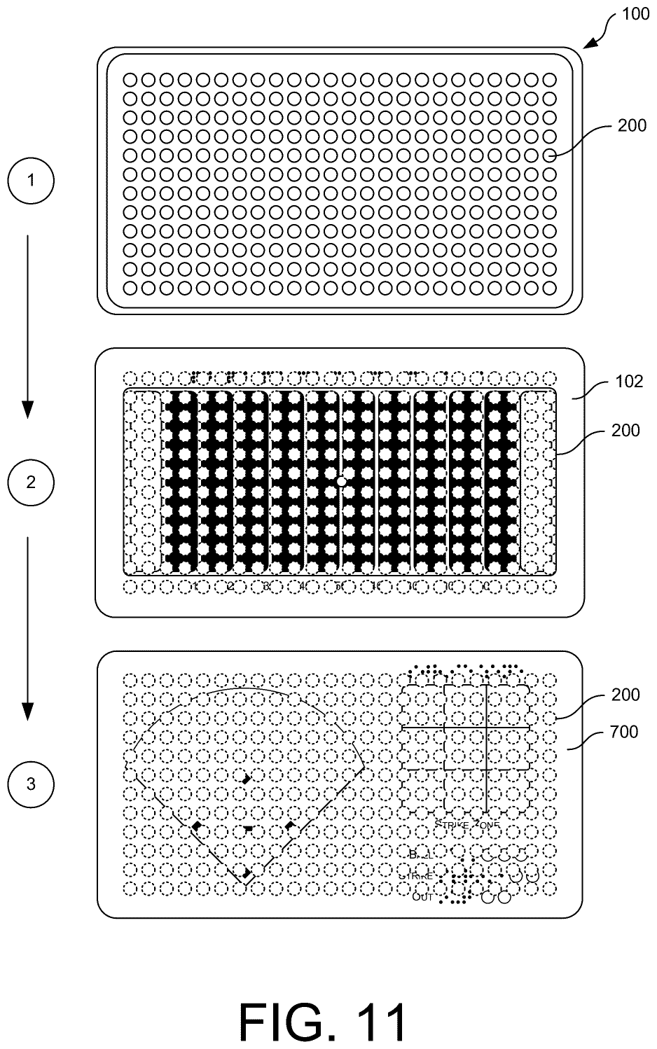

FIG. 11 illustrates an example scenario for interchanging the covers on the device 100, according to examples of the present disclosure. Initially, at “1” the covers may be decoupled from the device 100, or housings of the device 100. The actuator(s) 200 are shown being arranged in an array, grid, etc. In some instances, a membrane (e.g., the membrane 500), cover, film, etc., may be disposed over a top of the actuator(s) 200 to prevent debris entering the device 100 and impacting an operation of the actuator(s) 200.

At “2” in FIG. 11, the cover 102 is shown coupled to the device 100. The actuator(s) 200 are shown in dashed lines to indicate their position, placement, location, etc., beneath the cover 102. As shown, the cover 102 may correspond to a football field and certain actuator(s) 200 are located beneath endzones, yard-lines, etc. When the cover 102 couples to the device 100, an indication of the cover 102 (e.g., the cover data 124) may be received. This permits an understanding that the cover 102 is attached to the device 100, and correspondingly, how to output the haptics on the device 100. For example, if a tackle is made at the thirty-yard line, along the left hash mark, the actuator(s) 200 beneath or adjacent to this position may be actuated. Accordingly, using the map data 122 associated with the cover 102, those actuator(s) 200 adjacent to or at the location of the event 116 may be actuated. In addition, depending upon the cover installed, settings, functions of the buttons, and alterations to certain haptic effects may be adjusted.

At “3” in FIG. 11, the cover 700 is shown coupled to the device 100. The actuator(s) 200 are shown in dashed lines to indicate their position, placement, location, etc., beneath the cover 700. As shown, the cover 700 may correspond to a baseball field, as well as a strike zone, and certain actuator(s) 200 are located along the left field line, the right field line, the bases, zones of the strike zone, etc. The cover 700 may be interchanged with the cover 102 at any point, such as when the user desires to watch baseball instead of football. When the cover 700 couples to the device 100, an indication of the cover 700 (e.g., the cover data 124) may be received. This permits an understanding that the cover 700 is attached to the device 100, and correspondingly, how to output the haptics on the device 100. For example, a ball is hit to center field, the actuator(s) 200 beneath or adjacent to this position may be actuated. Accordingly, using the map data 122 associated with the cover 700, those actuator(s) 200 adjacent to or at the location of the event 116 may be actuated.

In some instances, not all of the actuator(s) 200 may be used and/or actuatable, depending upon the cover attached to the device 100. For example, at “3” some of the actuator(s) 200 are shown located outside the field of the play associated with the baseball field and/or outside the strike zone. These actuator(s) 200 may be deactivated when the cover 700 couples to the device 100, being as those actuator(s) 200 are located outside a field a play and/or are not associated with regions on the device 100 in which haptics are output. The device 100 and/or the remote computing resource(s) 104 may understand which of the actuator(s) 200 are capable of being actuated based on receiving the cover data 124. However, although the cover 102 and the cover 700 are shown, it is envisioned that other covers may couple to the device 100 and have different fields of play, sidelines, regions in which haptics are output, etc. In such instances, the cover data 124 may be used to indicate the cover coupled to the device 100, those actuator(s) 200 that are associated with respective positions on the field for outputting haptics, those actuator(s) 200 that are capable of being actuated, those actuator(s) 200 that are deactivated, and so forth.

Moreover, as shown in FIG. 11, the actuator(s) 200 may not perfectly align with certain points on the football field and/or the baseball field. For example, an actuator 200 may not be disposed exactly beneath second base on the cover 700. In these instances, the map data 122 may indicate the actuator(s) 200 adjacent to second base, or those actuator(s) 200 that are closest to second base for outputting haptics (e.g., if a player hits a double). Alternatively, in some instances, multiple actuators disposed around the location of the event may output haptics as a way to “blend” the haptics and represent the location of the event. However, in some instances, the points on the baseball field may be formed into the cover 700 such that, when coupled to the device 100, is disposed directly overhead of an actuator 200. As such, the tactile lines, points of the field, etc., may be formed on the covers 102 accordingly to coincide with points on the field.

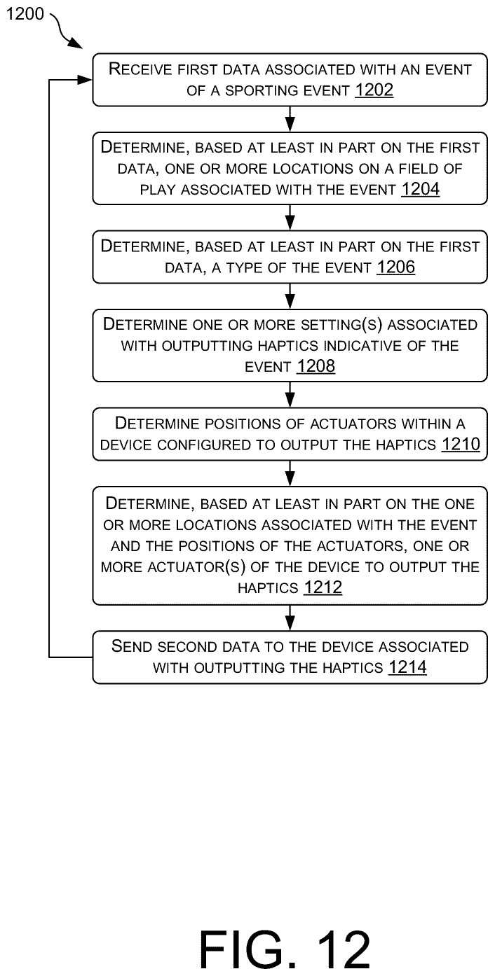

FIGS. 12-15 illustrates example processes (e.g., methods) associated with outputting haptics, according to examples of the present disclosure. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the processes, or alternative processes, and not all of the blocks need be executed. For discussion purposes, the processes are described with reference to the environments, devices, architectures, diagrams, and systems described in the examples herein, such as those described with respect to FIGS. 1-11, although the processes may be implemented in a wide variety of other environments, architectures, and systems.

FIG. 12 illustrates an example process 12000 associated with outputting haptics on the device 100, according to examples of the present disclosure.

At 1202, the process 1200 may include receiving first data associated with an event of a sporting event. For example, the remote computing resource(s) 104 may receive, from the data service(s) 112, the sporting event data 114. In some instances, the remote computing resource(s) 104 may receive the sporting event data 114 on a continual or predetermined basis, such as after an event 116 (e.g., play, maneuver, etc.) has taken place. The sporting event data 114 may include or indicate specifics of the event 116, such as a location of the event 116 within a field of play, a type of the event 116, characteristic(s) of the event 116, when the event 116 occurred, and so forth.

The sporting event data 114 that is received may be based at least in part on the type of the cover 102 coupled to the device 100. For example, if the cover 102 is associated with baseball, the sporting event data 114 may be baseball data, if the cover 102 is associated with football, the sporting event data 114 may be football data, and so forth. In some instances, the user may be permitted to select a sporting event from a plurality of sporting events to experience on the device 100. For example, the user may choose from a plurality of football games to experience on the device 100.

At 1204, the process 1200 may include determining, based at least in part on the first data, one or more locations on a field of play associated with the event. For example, the remote computing resource(s) 104 may determine where, on a field of play, for example, the event 116 occurred. In some instances, the event 116 may occur at different locations, such as a pass from a first location to a second location, a hit from a first location to a second location, a run from a first location to a second location, and so forth. As will be discussed herein, the locations are used for outputting haptics on the device 100 associated with the event 116. That is, knowing the location of the event 116, the remote computing resource(s) 104 may map the locations of the event 116 to certain locations on the device 100.

At 1206, the process 1200 may include determining, based at least in part on the first data, a type of the event. For example, the remote computing resource(s) 104 may determine whether the event 116 was a hit, flyout, homerun, etc., in baseball, whether the event 116 was a catch, run, touchdown, field goal, etc., in football, a steal, dunk, layout, field goal attempt, etc., in basketball, and so forth. In some instances, the type of the event 116 may be based on the sporting event being experienced by the user. As will be discussed herein, the type of the event 116 may be used to control haptics output on the device 100.

At 1208, the process 1200 may include determining one or more setting(s) associated with outputting haptics indicative of the event. For example, the setting(s) 128 may indicate a timing, intensity, duration, etc., at which to output the haptics on the device 100. In some instances, the setting(s) 128 may be based at least in part on the type of the event 116, such as whether the event 116 was a run, sack, touchdown, etc. Different types of the event(s) 116 may have different haptics. For example, a touchdown may be associated with haptics that are of a greater duration and/or intensity than a run. As another example, if a pass or run was a first down, the haptics may be of a greater duration than if the pass or run was not for a first down. The details of the event 116 for determining the setting(s) 128 may be indicated within the sporting event data 114. Moreover, in some instances, the user may set preference(s) in the profile(s) 136 associated with outputting the haptics, and the preference(s) may be accessed when determining the haptics to be output. As an example, for their football preferences, the user may prefer to have the events 116 of passes at a greater intensity, duration, etc., than events 116 of runs.

At 1210, the process 1200 may include determining positions of actuator(s) with a device configured to output the haptics. For example, using the cover data 124 and/or the map data 122, the remote computing resource(s) 104 may determine a location, position, etc., of the actuator(s) 200 within the device 100, or beneath the cover 102. Knowing the location of the actuator(s) 200 permits the location of the events 116 to be mapped to certain locations on the cover 102, whereby the actuator(s) 200 associated with the location on the cover 102 may be actuated. The remote computing resource(s) 104 may receive the cover data 124 from the device 100 for determining the cover 102 installed on the device 100, as well as the region(s) 126 of the cover 102 in which haptics are capable of being output. That is, not an entirety of the cover 102 may be associated with regions that output haptics. However, when the field of the play on the cover 102 is known, the remote computing resource(s) 104 determine those actuator(s) 200 that are associated with locations on the field of play for being able to instruct those actuator(s) 200 to actuate and output haptics.

At 1212, the process 1200 may include determining, based at least in part on the one or more locations associated with the event and the positions of the actuators, one or more actuator(s) of the device to output the haptics. For example, the mapping component 120 may map the location of the events 116 to certain actuator(s) 200 within the device 100. In some instances, the mapping component 120 of the remote computing resource(s) 104 may determine one, or multiple, actuator(s) 200 to actuate to output the haptics. In some instances, the remote computing resource(s) 104 may determine an actuator 200 closest located to the event 116 for outputting the haptics. In some instances, if a first of the actuator(s) 200 is selected to output the haptics (e.g., at the location at which the event occurs), one or more additional actuator(s) 200 may be selected to output haptics (e.g., around the event 116). The one or more additional actuator(s) 200 may provide a stereo effect to the event 116.

Those actuator(s) 200 that are actuated may be based on the setting(s) 128. For example, if a homerun occurs, all of the actuator(s) 200 within a field of play may be actuated. If a touchdown occurs, all of the actuator(s) 200 within the endzone may be actuated. As such, different setting(s) 128 may be used to characterize or represent different types of events. The setting(s) 128, as indicated above, may be defined by the user according to desired preference(s).

At 1214, the process 1200 may include sending second data to the device associated with outputting the haptics. For example, the remote computing resource(s) 104 may send the haptic data 130 to the device 100 for causing the device 100 to output the haptics and the actuator(s) 200 to actuate. In some instances, the haptic data 130 may indicate a timing at which to cause the actuator(s) 200 to actuate. The setting(s) 128 associated with outputting the haptics may also be sent to the device 100.

From 1214, the process 1200 may loop to 1202, whereby the remote computing resource(s) 104 may continue to receive the sporting event data 114 that indicates the events 116. For example, after each event 116 that occurs, the remote computing resource(s) 104 may receive the sporting event data 114 for determining the haptics to output on the device 100. Alternatively, multiple events 116 may be referenced or included within the sporting event data 111 and used by the remote computing resource(s) 104 to determine haptics for multiple events. In some instances, the sporting event data 114 may be associated with live or recorded sporting events.

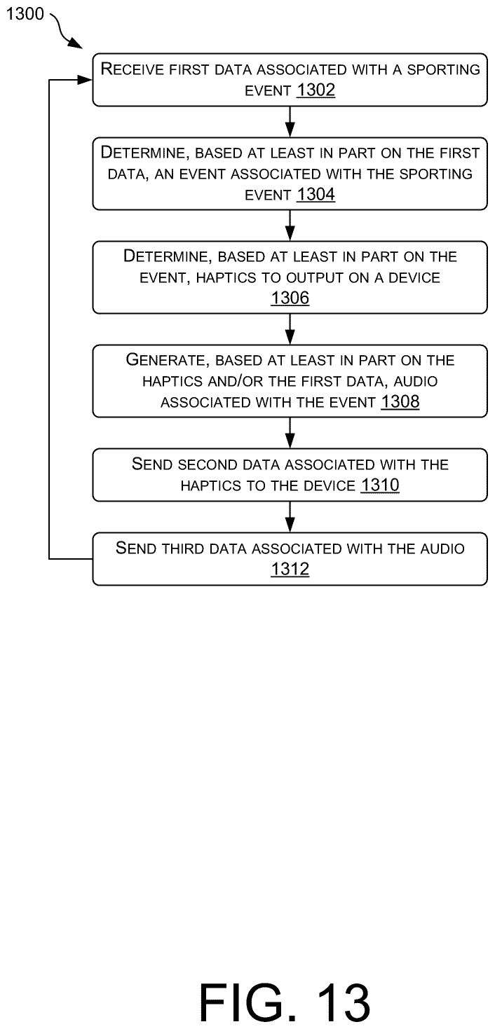

FIG. 13 illustrates an example process 1300 associated with determining haptics and audio to be output on the device 100, according to examples of the present disclosure.

At 1302, the process 1300 may include receiving first data associated with a sporting event. For example, the remote computing resource(s) 104 may receive, from the data service(s) 112, the sporting event data 114. The sporting event data 114 may indicate specific(s) of the events 116 taking place during a sporting event.

At 1304, the process 1300 may include determining, based at least in part on the first data, an event associated with the sporting event. For example, based on the sporting event data 114, the remote computing resource(s) 104 may determine the event 116. As part of determining the event 116, the remote computing resource(s) 104 may characterize the event 116, such as a type of the event 116, a location of the event 116 within a field of play, etc.

At 1306, the process 1300 may include determining based at least in part on the event, haptics to output on a device. For example, different events 116 may be associated with different haptics. The type of the event 116 may dictate the haptics that are output on the device 100. In this manner, the haptics are used to describe the event 116 taking place. Moreover, as part of determining the haptics, the remote computing resource(s) 104 may determine a location of the haptics, and/or which of the actuator(s) 200 to actuate to output the haptics.

At 1308, the process 1300 may include generating, based at least in part on the haptics and/or the first data, audio associated with the event. For example, based on the haptics and/or the sporting event data 114, the remote computing resource(s) 104 may determine audio associated with the event. Given that the haptics describe the event 116 taking place, in some instances, the haptics may additionally be used to generate the audio. As an example, if the haptics indicate an event 116 from the thirty-yard line to the forty-yard line, that the event 116 is a pass, players associated with the event 116, a type of pass, etc., the audio may be generated from such specifics. In other words, once the haptics are known to describe the event, the remote computing resource(s) 104 may use the haptics to generate the audio. Alternatively, using the sporting event data 114, audio may be generated that is descriptive of the events 116 represented within the sporting event data 114.

At 1310, the process 1300 may include sending second data associated with the haptics to the device. For example, the remote computing resource(s) 104 may send data associated with the haptics to the device 100.

At 1312, the process 1300 may include sending third data associated with the audio to the device. For example, the remote computing resource(s) 104 may send data associated with the audio to the device 100. The device 100 is configured to output the haptics in association with the audio to provide a realistic, non-delayed, experience. In some instances, the remote computing resource(s) 104 may send the data associated with the haptics and the data associated with the audio at the same time.

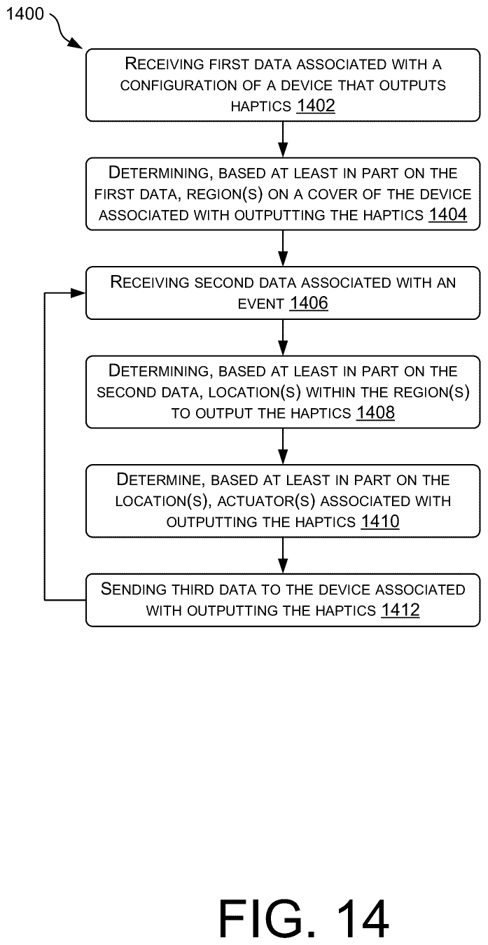

FIG. 14 illustrates an example process 1400 associated with determining haptics to be output on the device 100, according to examples of the present disclosure.

At 1402, the process 1400 may include receiving first data associated with a configuration of a device that outputs haptics. For example, the remote computing resource(s) 104 may receive data from the device 100 associated with a sporting event being experienced on the device 100. In some instances, the remote computing resource(s) 104 may receive the cover data 124 from the device 100 for determining the cover 102 coupled to the device 100. In other instances, the remote computing resource(s) 104 may receive an indication of the cover 102, a type of sporting event being experienced on the device 100, and may compare the indication to a stored list to determine the cover 102 coupled to the device 100. As will be explained herein, depending upon the cover 102, certain actuator(s) 200 may be actuated, the actuator(s) 200 may be mapped to certain locations on the cover 102 (e.g., field of play, etc.), corresponding sporting event data 114 may be received from the data service(s) 112, etc.

In some instances, the type of cover 102 may be automatically detected via the device 100, such as an RFID, pin connections, etc. Alternatively, in some instances, the device 100 may receive input from the user associated with the type of cover 102, a type of sporting event being experienced, etc.

At 1404, the process 1400 may include determining, based at least in part on the first data, region(s) on a cover of the device associated with outputting the haptics. For example, different covers 102 may have different regions, such as regions associated with a field of play, timing, scoring, players, strike zone, etc. As such, based at least in part on the cover 102 coupled to the device 100, different regions may output different information to the user to provide an immersive experience. As part of determining the cover 102, the remote computing resource(s) 104 may map the actuator(s) 200 to certain locations on the cover 102. For example, if a football cover is coupled to the device 100, the remote computing resource(s) 104 may map, determine, associate, etc., certain actuator(s) 200 with the endzone, the yard lines, etc. As such, when the events 116 occur, the remote computing resource(s) 104 is permitted to associate the events 116 with haptics output on the device 100.

At 1406, the process 1400 may include receiving second data associated with an event. For example, the remote computing resource(s) 104 may receive the sporting event data 114 from the data service(s) 112, whereby the sporting event data 114 indicates details of the events 116 taking place during a sporting event. In some instances, the sporting event data 114 associated with the events 116 may be received after completion of the event 116, such as a hit, throw, catch, serve, etc. For example, for football, if a pass is made from the thirty-yard line to the ten-yard line, the sporting event data 114 may be received after the catch is made. The sporting event data 114 may indicate the location on the field (e.g., hash mark) at which the throw was made, a location on the field at which the catch was made, a type of catch (e.g., jumping, sliding, diving, etc.), the players involved in the catch, etc.

At 1408, the process 1400 may include determining, based at least in part on the second data, location(s) within the region(s) to output the haptics. For example, based at least in part on the location associated with the events 116, the remote computing resource(s) 104 may map the locations of the event 116 to certain locations within the region(s) 126. Using the above example, the remote computing resource(s) 104 may determine those locations on the cover 102 that are associated with the throwing location and/or actuator(s) 200 that are associated with the catch location.

At 1410, the process 1400 may include determining, based at least in part on the location(s), actuator(s) associated with outputting the haptics. For example, knowing the locations within the region(s) 126 associated with the events 116, the remote computing resource(s) 104 may determine the actuator(s) 200 to output the haptics. For example, the actuator(s) 200 may respectively vibrate to indicate to the user a location on the cover 102 (or the football field depicted on the cover 102) corresponding to the throwing location and the catch location. In some instances, the map data 122 may be used to map the locations of the events 116 to the actuator(s) 200 on the cover 102 (or the regions) associated with the locations.

In some instances, the remote computing resource(s) 104 may generate data associated with the event 116. For example, knowing the throwing location and the catch location, the remote computing resource(s) 104 may determine a path, trajectory, line, etc., between the throwing location and the catch location. Actuator(s) 200 that are disposed along the path may output haptics to increase fidelity. For example, knowing the path of the football from the throwing location and the catch location may provide a more immersive experience for the user.

At 1412, the process 1400 may include sending third data to the device associated with outputting the haptics. For example, the remote computing resource(s) 104 may send data to the device 100 that causes the device 100 to actuate the actuator(s) 200. From 1412, the process 1400 may loop to 1406, whereby the remote computing resource(s) 104 may continue to receive data associated with the events 116. For example, after each event 116 that occurs, the remote computing resource(s) 104 may receive the sporting event data 114 for determining the haptics to output on the device 100. In some instances, the sporting event data 114 may be associated with live or recorded sporting events.

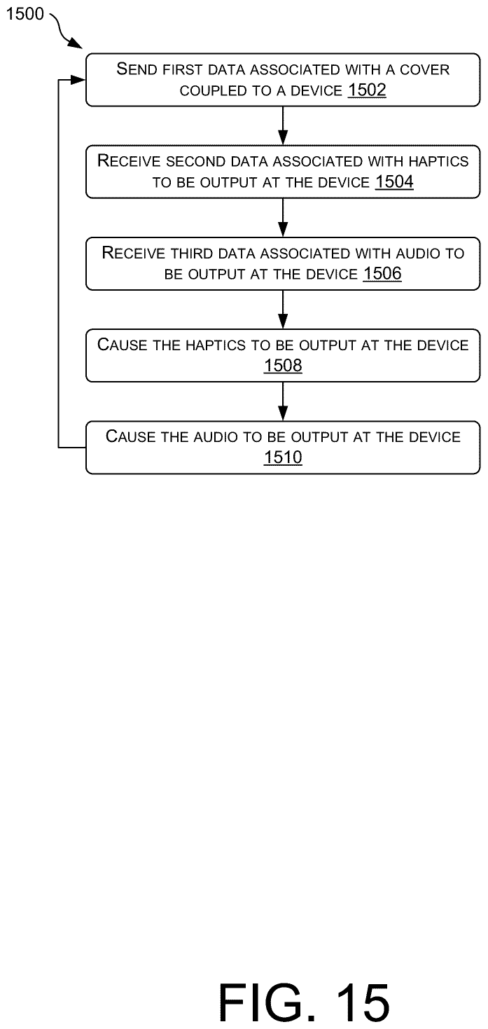

FIG. 15 illustrates an example process 1500 associated with outputting haptics and/or audio at the device 100.

At 1502, the process 1500 may include sending first data associated with a cover coupled to a device. For example, the device 100 may send, to the remote computing resource(s) 104, data associated with the cover 102 coupled to the device 100. The data, which may include the cover data 124, may indicate the sporting event associated with the cover 102, areas of the cover 102 that are configured to output haptics (e.g., the actuator(s) 200 that are activated), areas of the cover 102 that are not configured to output haptics (e.g., the actuator(s) 200 that are deactivated), etc.

At 1504, the process 1500 may include receiving second data associated with haptics to be output at the device. For example, the device 100 may receive, from the remote computing resource(s) 104, data that indicates the haptics to be output at the device 100. In some instances, the data may include the haptic data 130 and/or the setting(s) 128. The data may indicate the actuator(s) 200 to actuate based on the events occurring during the sporting event. As discussed herein, the remote computing resource(s) 104 may determine the event(s) 116 and the haptics to output at the device 100.

At 1506, the process 1500 may include receiving third data associated with audio to be output at the device. The audio may be generated by the remote computing resource(s) 104 and/or broadcasts that provide commentary to the sporting event. In some instances, the remote computing resource(s) 104 may generate the audio data 134 based on the events 116, such as characteristic(s) of the events 116. For example, if the event 116 is a diving catch at the endzone, which may be determined from the sporting event data, the audio data 134 may be generated to indicate such. In some instances, the remote computing resource(s) may leverage AI or ML model(s) to generate the audio data 134.

At 1508, the process 1500 may include causing the haptics to be output at the device. For example, upon receipt of the second data, the device 100 may cause the actuator(s) 200 to be actuated. The second data received from the remote computing resource(s) 104 may indicate which of the actuator(s) 200 to actuate. As such, upon receipt of the second data, the device 100 may carry out performance of the haptics in association with the instructions.

At 1510, the process 1500 may include causing the audio to be output at the device. For example, upon receipt of the third data, the device 100 may output the audio via speakers of the device 100 (e.g., the I/O component(s) 210) and/or the device 100 may include an audio jack for outputting audio over headphones. The device 100 may also communicatively couple to wireless headphones for causing the audio to be output. In some instances, the audio may be synchronized with the haptics output by the actuator(s) 200. In some instances, the audio may be delayed (e.g., via a buffer) to synchronize the audio with the haptic being output. For example, as the sporting event is taking place in real-time, the sporting event data 114 may be generated at a delay. In turn, the haptic data 130 received from the remote computing resource(s) 104 may be received at a delay as compared to the audio data 134 (which may include a lesser delay). In some instances, using time stamps, for example, the audio and the haptics may be output synchronously.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A device comprising:
a housing;
a cover configured to couple to the housing, the cover including one or more tactile features associated with a field of play of a sporting event;
a plurality of actuators disposed within the housing, the plurality of actuators being configured to actuate to provide haptic outputs on the cover;
one or more processors, and
one or more computer-readable media storing instructions that, when executed, cause the one or more processors to perform operations including:
receiving, from one or more remote computing resources, data indicative of an event associated with the sporting event,
determining, based at least in part on the data, at least one actuator of the plurality of actuators to actuate, and
causing the at least one actuator of the plurality of actuators to actuate to provide a haptic output on the cover.

2. The device of claim 1, the operations further including:
at least one of:
receiving, from the one or more remote computing resources, audio data associated with the event, or
generating, based at least in part on the event, the audio data; and
causing the audio data to be output.

3. The device of claim 1, the operations further including:
determining a type of cover coupled to the housing; and
sending, to the one or more remote computing resources, second data associated with the type of cover, wherein the one or more remote computing resources are configured to determine regions of the cover to provide the haptic output based at least in part on the second data.

4. The device of claim 1, wherein the cover is removably coupled to the housing, further comprising a second cover configured to couple to the housing, the second cover including at least one of:
one or more second tactile features associated with a second field of play of a second sporting event, the one or more second tactile features being different than the one or more tactile features, and the second field of play being different than the field of play, or
one or more third tactile features associated with at least one of a scoring, a timing, or a portion of the second field of play.

5. The device of claim 1, wherein causing the at least one actuator to actuate includes causing the at least one actuator to actuate at a first instance in time, the operations further including:
determining, based at least in part on the data, at least one second actuator of the plurality of actuators to actuate, the at least one second actuator being different than the at least one actuator, and
causing the at least one second actuator of the plurality of actuators to actuate to provide a second haptic output on the cover at a second instance in time that is at least partially after the first instance in time.

6. The device of claim 1, the operations further including:
receiving, from the one or more remote computing resources, second data indicative of a second event associated with the sporting event; and
causing, based at least in part on the second event, an output at the device.

7. A device comprising:
a housing;
a cover coupled to the housing, the cover including:
a first surface having:
one or more regions at which haptics are output,
one or more tactile features associated with a sporting event, and
one or more braille characters; and
a second surface opposite the first surface;
a plurality of actuators disposed within the housing and adjacent to the second surface, the plurality of actuators being configured to actuate to output haptics within the one or more regions;
one or more processors; and
one or more computer-readable media storing instructions that, when executed, cause the one or more processors to perform operations including:
receiving data associated with at least one actuator of the plurality of actuators to actuate, and
causing, based at least in part on the data, the at least one actuator to actuate to output a haptic within the one or more regions.

8. The device of claim 7, wherein the one or more regions include at least one of:
a first region associated with a field of play of the sporting event;
a second region associated with one or more of a scoring, a timing, a player, or analytics associated with the sporting event; or
a third region associated with a portion of the field of play.

9. The device of claim 7, wherein the data is associated with a first event of the sporting event, the operations further including:
receiving second data associated with at least one second actuator of the plurality of actuators to actuate, the second data being associated with a second event of the sporting event; and
causing, based at least in part on the second data, the at least one second actuator to actuate to output a second haptic within the one or more regions.

10. The device of claim 9, wherein:
the at least one actuator is actuated at a first instance in time; and
the at least one second actuator is actuated at a second instance in time that is after the first instance in time.

11. The device of claim 9, wherein:
causing the at least one actuator to actuate comprises at least one of:
causing the at least one actuator to actuate for a first duration,
causing the at least one actuator to actuate at a first intensity, or
causing the at least one actuator to actuate at a first region within the one or more regions; and
causing the at least one second actuator to actuate comprises at least one of:
causing the at least one second actuator to actuate for a second duration,
causing the at least one second actuator to actuate at a second intensity, or
causing the at least one second actuator to actuate at a second region within the one or more regions.

12. The device of claim 7, wherein the cover is removably coupled to the housing, further comprising a second cover configured to couple to the housing, the second cover including one or more second tactile features associated with a second sporting event, the one or more second tactile features being different than the one or more tactile features.

13. The device of claim 7, wherein the plurality of actuators are at least one of:
engaged with the second surface to impart the haptics to the cover; or
configured to actuate to engage with the second surface to impart the haptics to the cover.

14. The device of claim 7, the operations further including:
receiving audio data; and
causing output of the audio data in association with causing the at least one actuator to actuate.

15. A device comprising:
a housing;
a cover coupled to the housing;
a printed circuit board (PCB) disposed within the housing;
actuators disposed on the PCB, the actuators being configured to actuate to output haptics on the cover; one or more processors, and
one or more computer-readable media storing instructions that, when executed, cause the one or more processors to perform operations including:
receiving first data associated with at least a first actuator of the actuators to actuate,
determining a first setting associated with actuating the at least the first actuator,
causing the at least the first actuator to actuate according to the first setting,
receiving second data associated with at least a second actuator of the actuators to actuate, the at least the second actuator being different than the at least the first actuator,
determining a second setting associated with actuating the at least the second actuator, and
causing the at least the second actuator to actuate according to the second setting.

16. The device of claim 15, wherein the cover includes at least one of:
one or more tactile features associated with a field of play of a sporting event; or
one or more braille characters associated with the field of play of the sporting event.

17. The device of claim 15, wherein the cover is configured to removably couple to the housing, further comprising a second cover configured to couple to the housing, the second cover being different than the cover.

18. The device of claim 15, further comprising one or more network interfaces, the operations further including:
determining a type of the cover; and
sending, via the one or more network interfaces, third data associated with the type of the cover, wherein the third data is associated with determining the haptics to output on the cover.

19. The device of claim 15, the operations further including:
receiving first audio data;
causing output of the first audio data in association with causing the at least the first actuator to actuate;
receiving second audio data; and
causing output of the second audio data in association with causing the at least the second actuator to actuate.

20. The device of claim 15, wherein:
the cover includes:
a first region in which the haptics are output, and
a second region in which the haptics are output;
the at least the first actuator is disposed within the first region; and
the at least the second actuator is disposed within the second region.
